(19) United States
(12) Patent Application Publication
(10) Pub. No.: US 2026/0092441 A1
(43) Pub. Date: Apr. 2, 2026

(54) MODULAR BUILDING SYSTEM

(71) Applicant: Abode Industries Limited, Bridlington Yorkshire (GB)

(72) Inventors: John Arthur, Bridlington Yorkshire (GB); Robert Barker, London Greater London (GB)

(21) Appl. No.: 19/111,619

(22) PCT Filed: Sep. 12, 2023
(86) PCT No.: PCT/GB2023/052352

§ 371 Date: Mar. 13, 2025

(30) Foreign Application Priority Data
Sep. 13, 2022 (GB) 2213356.5

(51) Int. Cl. E04B 1/343; B32B 3/06; B32B 3/30; B32B 9/04; B32B 21/02; B32B 21/04; B32B 21/08; B32B 27/38; B32B 27/40

(52) U.S. Cl. CPC E04B 1/34321; B32B 3/06; B32B 3/30; B32B 9/042; B32B 21/02; B32B 21/047; B32B 21/08; B32B 27/38; B32B 27/40; B32B 2266/0278; B32B 2307/3065; B32B 2307/7265; B32B 2419/00

(57) ABSTRACT

A system comprising modular parts arranged to be assembled to form at least part of a structure, the system including: a plurality of interengageable modules arranged to be fixed together; wherein the plurality of modules comprises at least one module forming an opening in the structure; wherein each module includes one or more frame elements; and wherein the modules are arranged such that in the assembled structure, the frame elements of the module at least partly transmit loads between adjacent modules, through the structure.

The present invention relates to a modular building system.

The construction and installation of prefabricated volumetric modular housing units and prefabricated volumetric modular commercial units is known. Prefabricated volumetric modular units are portions of buildings which are made using elements that are manufactured offsite, before being transported and installed.

Structures of this type are made from various types of materials including wood, metal, plasterboard, insulation and preformed concrete. In some cases, prefabricated volumetric modular building units are produced, and transported already assembled by the manufacturer, already containing amenities necessary for the building such as water and electrical systems. Therefore, the installation only involves the transport, interconnection and deposition of the structure.

However, ready to use prefabricated volumetric modular building units are not interchangeable or interconnectable in a manner such that units can be joined in any way to make a variety of different buildings. The designs are typically bespoke inasmuch as the layout is established and defined at the production stage and is not flexible when manufactured. Typically a designed module can only be used for a single customer. Furthermore, these prefabricated modular building units, or even parts of the prefabricated units, are bulky, making their transportation difficult. Furthermore, installing these units or parts of units involves the use of specialist lifting equipment onsite.

Prefabricated units also exist on the market that can be assembled or made by combining and assembling industrially produced elements such as panels, beams and the like. However, in the case of housing units to be assembled, the considerable time and cost involved in the assembly and installation of prefabricated elements must be taken into account. Again, these modular elements are typically bespoke and not interchangeable with other buildings. Considerable effort is required in the design of each building.

Another known element for making at least partly pre-formed buildings is Structural Insulated Panels (SIPs). SIPs are typically made of various simplistic parts providing a rudimentary insulated structure which is self-supporting. The SIP may simply include a layer of insulation between two structural boards. These are typically of standard construction and require considerable effort in the design and modification of the panels during construction and no external or internal surfaces, utilities or amenities are integrated.

According to a first aspect of the invention, there is provided a system comprising modular parts arranged to be assembled to form at least part of a structure, the system including: a plurality of interengageable modules arranged to be fixed together; wherein the plurality of modules comprises at least one module forming an opening in the structure; wherein each module includes one or more frame elements; and wherein the modules are arranged such that in the assembled structure, the frame elements of the module at least partly transmit loads between adjacent modules, through the structure.

Each module may have a first face and an opposing second face, the first and second faces parallel to each other and separated by a thickness of the module. Each module further includes one or more of: first frame at or near the first face of the module, defining a surface parallel to the first face of the module; a second frame at or near the second face of the module, defining a surface parallel to the second face of the module; and a peripheral frame element extending around the periphery of the module, between the first face and the second face, the first frame element defining edge faces facing outward from the module, perpendicular to the first face and the second face.

A first set of the plurality of modules may comprise one or more layers. Each module in the first set may comprise a plurality of layers arranged in a stack, wherein the plurality of layers includes a core material arranged to bind at least some of the plurality of layers into a composite structure, wherein the composite structure is arranged to at least partly transmit loads between adjacent modules.

A volume defined between two layers of the plurality of layers and/or one or more frame elements may be filled with the core material. The core material may comprise a thermally insulative material.

The one or more layers comprise one or more of: an inner skin; an outer skin; thermal insulation; a soundproofing layer; a vapour seal layer; a weather resistant layer; a fire resistant layer; a service layer comprising at least a portion of one or more channels for supply of building services and/or removal of waste water and/or rain water; a transparent layer; a glazing layer; a protective or security layer; an energy generating layer for renewable energy generation.

The one or more layers may include the service layer. The channels may be formed in the body of the layers or recessed into a face of the module.

At least some of the layers may be retained between two frame elements.

At least some of the one or more frame elements may comprise an opening. At least some of the layers may be received in the central opening of one of the frame elements. The opening may be central. The opening may be surrounded by the frame elements on all sides.

At least one face of the module may comprise fixation points to suspend internal or external furniture, fixtures, equipment and finishes, or temporary elements for assembling the system. The fixation points may be formed in one of the frame elements.

The system may comprise sealing elements arranged to form seals between adjacent modules, the seals integral with the modules. The seals may comprise one or more of: weather/environmental seals, fire seals, acoustic seals.

The plurality of modules may be arranged to form walls. The system may further comprise one or more posts arranged to join modules extending in parallel or non-parallel directions, the posts interengeagable with the modules. The posts may enclose conduits for transport of sewage waste, ventilation and rainwater disposal. Alternatively, the system may further comprise one or more modules having means to connect to another module in a non-parallel direction.

The structure may be arranged on an at least a double grid layout, such that at least some of the dimensions of at least some of the modules corresponds to a unit on the grid. For example, the width and/or height and/or thickness of each module may correspond to a unit on the grid. The structure may define a closed perimeter, and wherein at least two walls of the perimeter of the assembled structure are arranged off the grid. Only exterior modules, arranged to form the closed perimeter, may be off the grid.

The system may be arranged to form a structure having multiple storeys. Each module may have a height such that the combination of modules forming the height of a storey has a corresponding to an integer multiple of the height of a step of a staircase in the building. For example, each module may have a height corresponding to an integer multiple of a step of the staircase. At least some of the modules may have a width corresponding to an integer multiple of the depth of a tread of a staircase in the building.

The system may comprise one or more modules arranged to form a roof. The system may further comprise one or more eaves modules, each eaves module interengeagable with modules forming walls, and modules forming a roof, wherein the one or more eaves module are arranged such that the roof joins the wall at a non-parallel or perpendicular angle. The eaves module may include a gutter channel for carrying rain water from the roof. The system may comprise a ridge module arranged to join non parallel roof modules. The system may also comprise valley, hip and verge modules to form the roof.

The system may comprise one or more modules arranged to form a floor. A ceiling of an enclosed space may be suspended from the floor of an upper storey

The system may include one or more modules that are arranged to form walls, wherein the one or more modules arranged to form walls may include interengaging projections arranged to engage with the one or more modules arranged to form a floor.

The opening may form one of the following: a door; a window; a rooflight; a vent; an access hatch; a service access; a servery opening.

The modules may be engageable to form part or all of a building envelope. The system may be arranged to form interior divisions within the building envelope.

The system may comprise one or more of: a plurality of modules arranged to form a staircase; a plurality of modules arranged to form a ramp; a plurality of modules arranged to form a lift shaft.

According to a second aspect of the invention, there is provided a kit comprising a predefined set of modules from the system of the first aspect, the kit arranged to form a predefined structure.

According to a third aspect there is provided a building formed by the system the first aspect or the kit of the second aspect.

According to a fourth aspect of the invention, there is provided an interlocking system for connecting modules of a modular building system, the interlocking system comprising: a female member arranged to be secured to an edge surface of a first module, the female member comprising: a face extending parallel to and spaced from the edge surface of the first module to form a channel between the first module and the face; and a plurality of slots formed in the face extending into the channel; a male member arranged to be secured to an edge surface of a second module, the male member comprising: at least one location projection extending along a first direction, perpendicular to the edge surface of the second module; and at least one locking projection extending along the first direction, wherein when the female member and male member are engaged, each location projection extends through one of the plurality of slots formed in the face of the female member to align the first module and second module and each locking projection extends through one of the plurality of slots formed in the face of the female member; and a locking member arranged to be received in the channel formed by the female member, the third locking member comprising: a plurality of slots arranged such that when the female member, male member and locking member are engaged, each location projection extends through one of the plurality of slots in locking member and each locking projection extends through one of the plurality of slots formed in the locking member to form an interference fit between the locking projection and the female member, to join the modules together.

Each locking projection may have a length parallel to the edge surface of the second module, and a width extending away from the second module. Each locking projection may comprise: a slot extending from a first edge of the locking projection for a portion of the length of the locking projection, the slot formed partway along the width of the locking projection, wherein a top of the slot of the locking member engages the bottom of the slot in the locking projection.

The top of the slot in the female member may engage the top of the locking projection, between the slot and the second module. The slot in the locking member may be shaped to guide the female and male members into a tight interference fit.

The locking projection may be shaped such that as the locking member is inserted into place, a clamping force is applied between the female member and male member.

The location projection may be shaped to ensure proper alignment between the first module and the second module along a direction the female member and male member extend.

The top and bottom of the location projection may be chamfered.

Each of the slots in the female member that is arranged to receive a location projection may be shaped to guide the first module and the second module into alignment along a direction perpendicular to the direction the female member and male member extend.

The top and bottom of each of the slots in the female member arranged to receive a location projection may be narrowed.

The location projections may extend further from the second module than the locking projections.

The slots in the locking member may be longer than the slots in the female member, in the direction the female and male members extend.

The interlocking system may have: a first configuration in which the locking member is received in the channel of the female member such that the slots in the locking member align with the slots in the female member, and the locking member is vertically displaced with respect to the female member; and a second configuration in which the location projections and locking projections of the male member extend through the slots in the locking member and the female member, and the locking member is vertically aligned with respect to the female member, to engage the interlocking system. The interlocking system may be transported in the first configuration. In the first configuration, the locking member and female member may be held in place by a frangible connector extending between the locking member and female member. The frangible connector may be a pin or dowel extending through aligned apertures in the locking member and female member.

The modules in the building system of the first aspect may be engageable using the interlocking system of the fourth aspect.

The kit of the second aspect may comprising modules that are engageable using the interlocking system of the fourth aspect.

The building of the third aspect may be made using modules engageable using the interlocking system of the fourth aspect.

According to further aspects of the invention, there are provided any of the different modules discussed above individually, or any subset of the modules to form a part of a structure, such as a wall, roof, ceiling, stairway or other feature of the structure.

At least some of the aspects of the invention provide a modular building system which has interchangeable, standard components and contains no bespoke parts. The components can be manufactured on automotive style production lines to produce accurate, high quality and repeatable modular and interchangeable units in a fully scalable and high-volume manner which can be used on any structure and have no bespoke element of design at module level.

Furthermore, the standard components are sized and shaped so that no specialised delivery or lifting equipment is required during assembly, and no modification is needed on site, reducing time taken on sight, the skilled needed for assembly, and waste created that needs to be removed from the site. A building constructed from the system may only take a few days to assemble on site.

Since there are no bespoke elements, the traditional manufacturing delays and are avoided. At least some of the aspects of the invention allow for Computer Aided Design optimisation for determining the set of modules required for any particular structure. These modules can be costed and itemised instantaneously and added to an itinerary for immediate delivery (for example next day).

The modules and other components can easily be made such that the final structure conforms to local building regulations.

The modules and other components may also contain the infrastructure required to incorporate all the amenities such as kitchens, ablutionary and/or sanitary rooms, plant, offices and bedrooms in one building. The modules include all the routing channels for utilities, such as but not limited to, plumbing and electrical connections already integrated.

The modules and standard components provide a load bearing capability in which the load of an adjacent module or component may be transferred through the composite frame element or frame element alone of the module or standard component to form a structure. The load bearing capability may also be used to bear furniture, fixtures, equipment and external and internal finishes. This may also include temporary fixings including scaffolding.

A structure made using at least some of the aspects of the invention may be weatherproof without application of cladding panels. However, the building may also have the capability to have an aesthetic skin fitted to the preferences of the owner. The style can be adopted to comply with local building preferences or corporate style. The skin may also be replaced by an alternate skin at a future date.

The system may include roofing, flooring, foundations, guttering, stairways, kitchen, bathrooms, internal finishes, furniture and ceiling modules.

The building may have integrated solar Photo Voltaic (PV) modules into the roofing design and electricity storage within the building, these modules may be a separate cladding layer on the outside of the roof modules. Areas of roof with no solar panels may be matched in design to provide an integrated and almost seamless planar roof.

The building may include external fixings for attachment of modular scaffolding for safety of workers during construction.

All the modules may be designed to be compliant to a number of units of a double (or more) grid and therefore interchangeable in location. The use of a grid allows for inclusion of doors, windows, pillars, flooring, stairs and roofing modules in accordance with the grid but not limited to location.

In the interlocking system, the use of location projections that are longer than locking projections ensures the location projections engage first, so that the male and female elements are located relative to each other with high accuracy before locking.

In the interlocking system, the profiling of the location tongue means that the adjacent modules do not need to be exactly vertically aligned when they are being connected. Similarly, the profiling of the slot in the female member means that the modules do not need to be exactly horizontally aligned when they are being connected. The profiling brings the two modules into the correct horizontal and/or vertical alignment as the modules are being connected.

In the interlocking system, the male member and female member end up in a tight interference fit to ensure they are accurately fitted together. The profiling of the top of the slots in the locking member helps ensure the interference fit to an accuracy of greater than 0.1 mm. The locking projection is profiled to ensure that when the two modules are connected, the connection may be tensioned to ensure high clamping force.

Use of the frangible member ensures the locking device is held in the correct position for connection of the interlocking system, and the system is easy to make.

It will be appreciated that features and advantages discussed with reference to any particular aspect may be applied mutatis mutandis to any other aspect, unless mutually exclusive.

Embodiments of the invention will now be described, by way of example only, with reference to the accompanying drawings, in which:

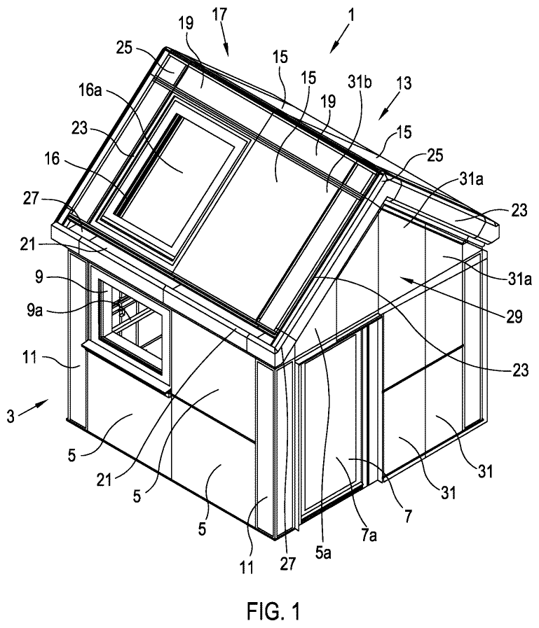

FIG. 1 illustrates an example structure made using a modular building system according to an embodiment of the invention;

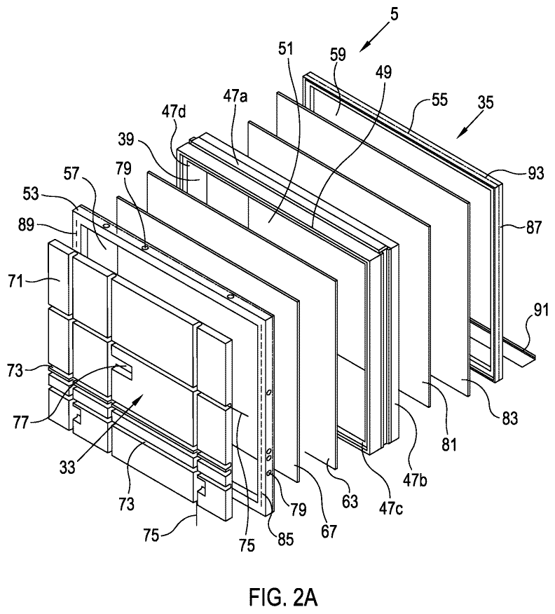

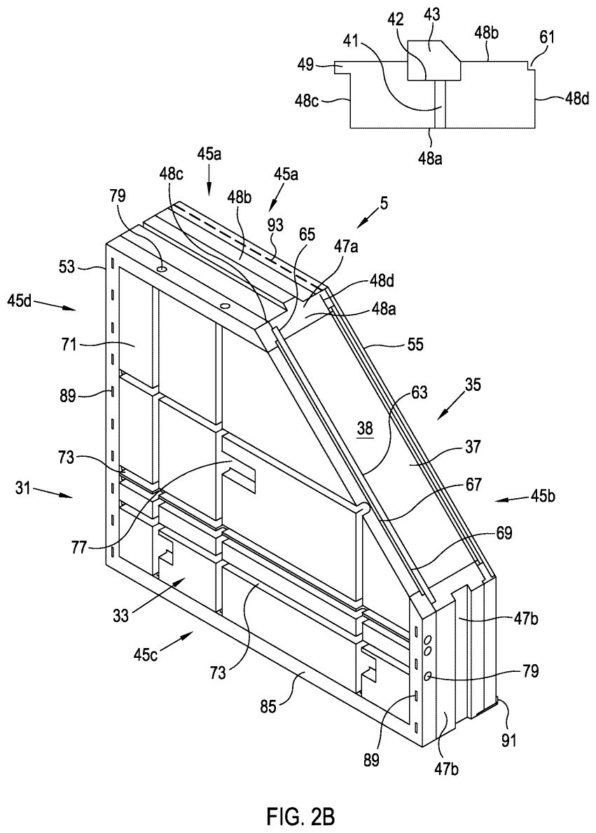

FIG. 2A illustrates a wall module of the structure of FIG. 1 in exploded view;

FIG. 2B illustrates the wall module of FIG. 2A when assembled, with a cut through section at the corner;

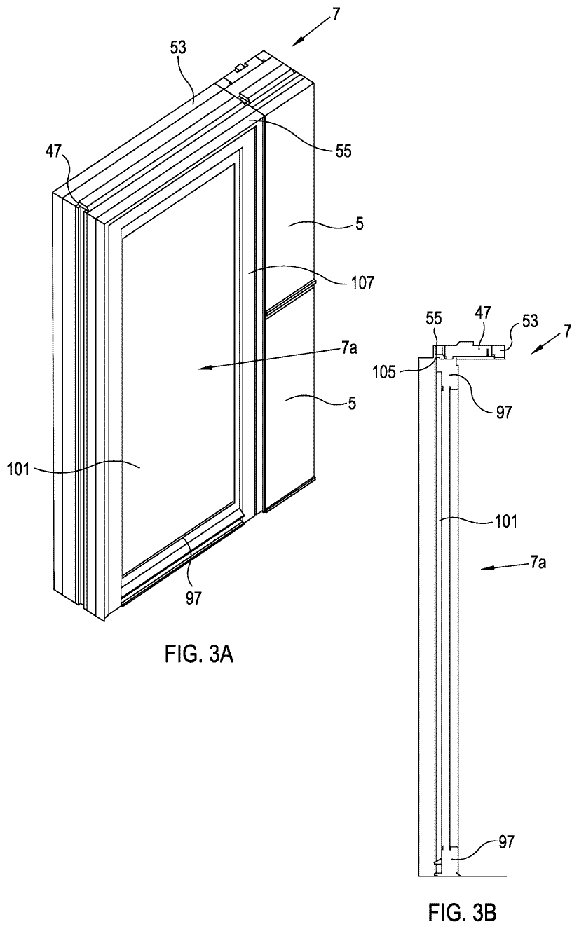

FIG. 3A illustrates a door module of the structure of FIG. 1;

FIG. 3B illustrates a section through the door module of FIG. 3A;

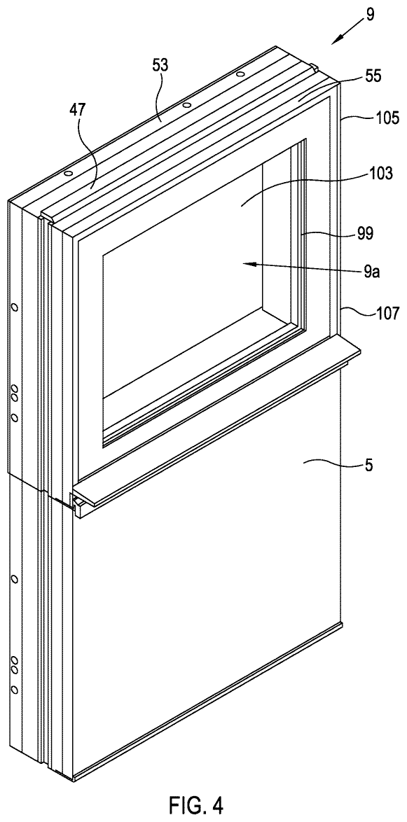

FIG. 4 illustrates a window module of the structure of FIG. 1;

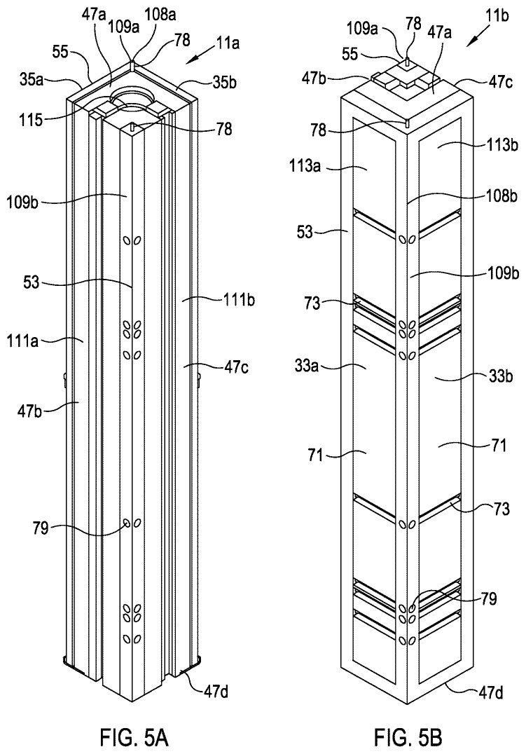

FIG. 5A illustrates a first example of a corner post of the structure of FIG. 1;

FIG. 5B illustrates an alternative example of a corner post;

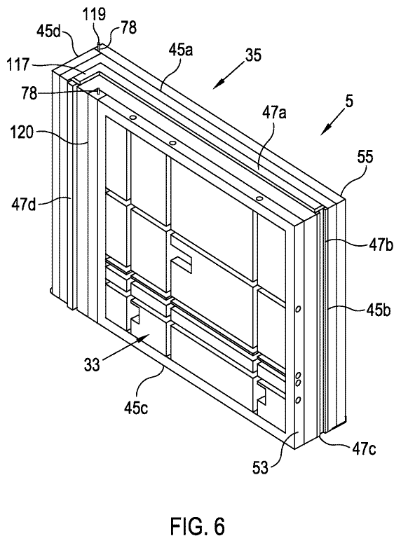

FIG. 6 illustrates a wall panel of a modular building system, with an integrated corner;

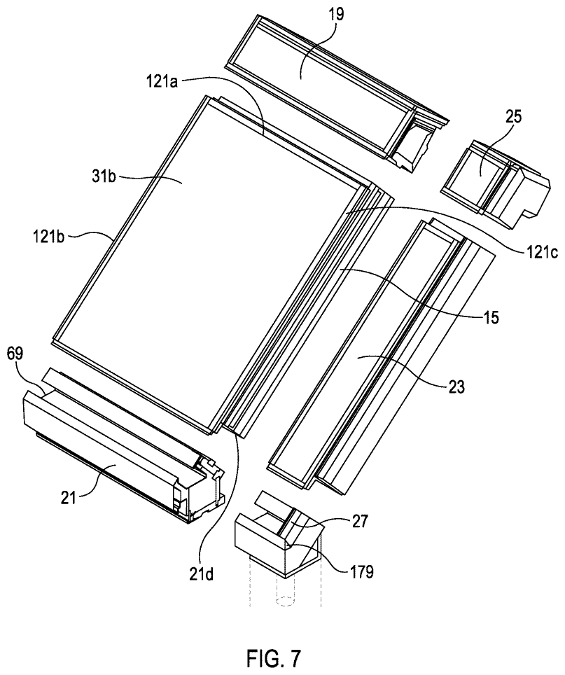

FIG. 7 illustrates a part of the roof of the structure of FIG. 1, in exploded view;

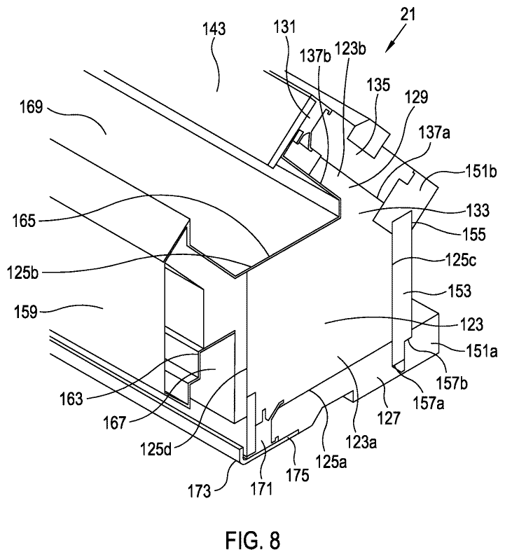

FIG. 8 illustrates an eaves module used in the roof of FIG. 7;

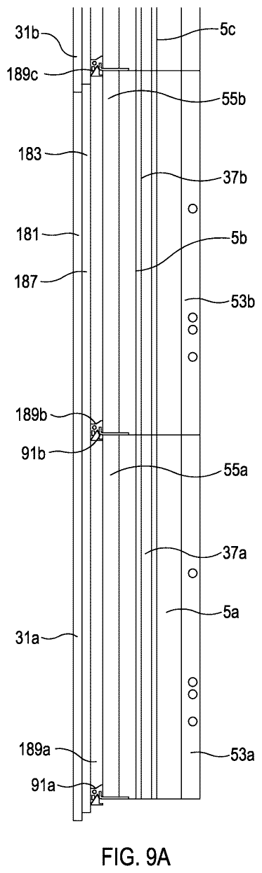

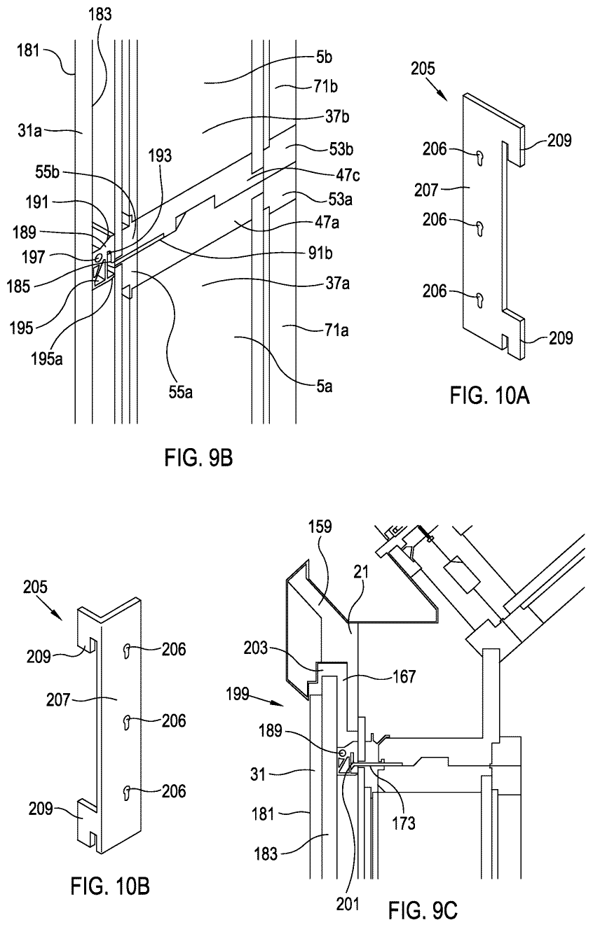

FIG. 9A illustrates a section view through a wall of the structure of FIG. 1, with a cladding panel installed;

FIG. 9B illustrates the attachment of the cladding panel in more detail;

FIG. 9C illustrates the engagement of the cladding panel with the eaves module;

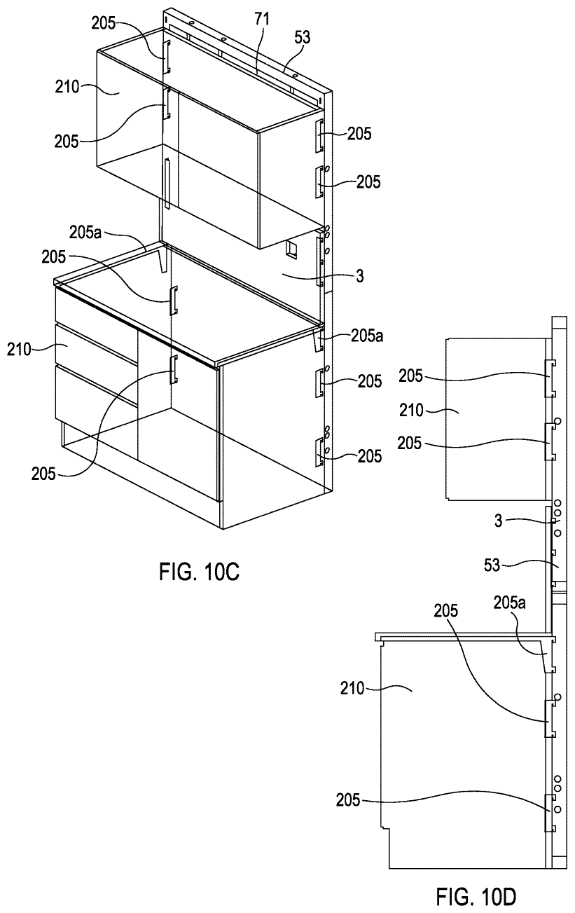

FIG. 10A illustrates a first example of a support bracket for installation of interior furniture in the structure of FIG. 1;

FIG. 10B illustrates a second example of a support bracket for installation of interior furniture and finishes in the structure of FIG. 1;

FIG. 10C illustrates an example of the mounting of internal fixtures using the support bracket of FIG. 10A and the support bracket of FIG. 10B, in isometric view;

FIG. 10D illustrates an example of the mounting of internal fixtures using the support bracket of FIG. 10A and the support bracket of FIG. 10B, in side on view;

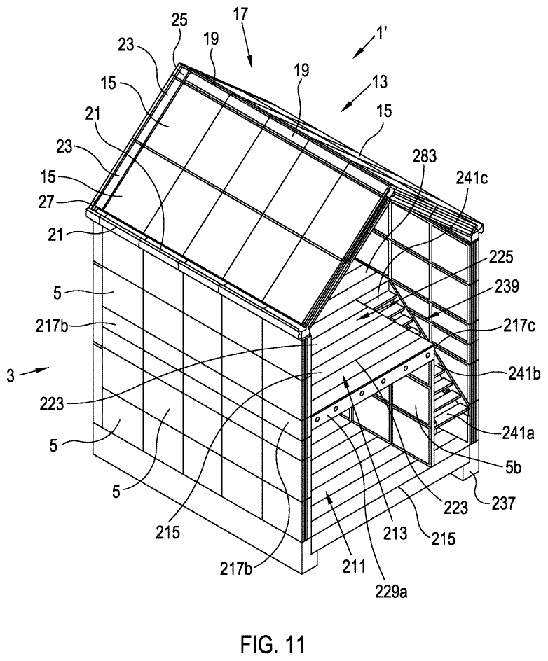

FIG. 11 illustrates an alternative cutaway structure formed using the modular building system according to an embodiment of the invention;

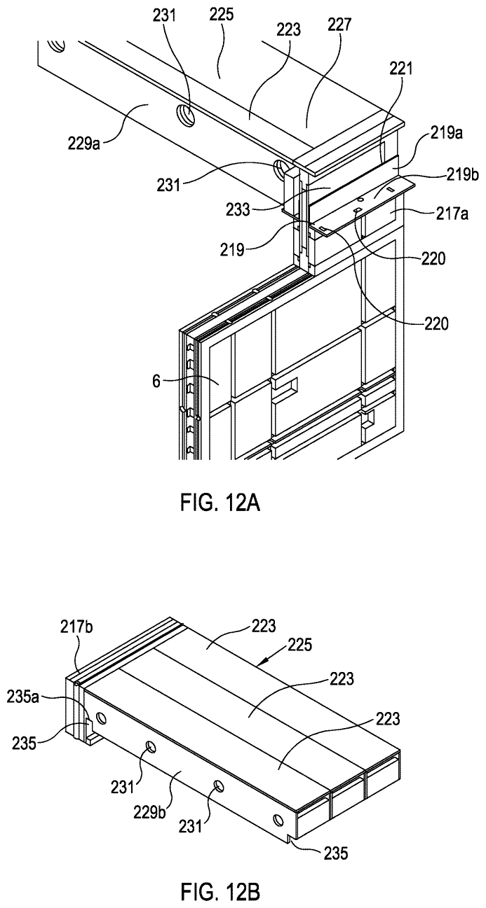

FIG. 12A illustrates the connection of the floor of the structure of FIG. 1 to an internal wall module;

FIG. 12B illustrates the connection of the floor of the structure of FIG. 1 to an external wall module;

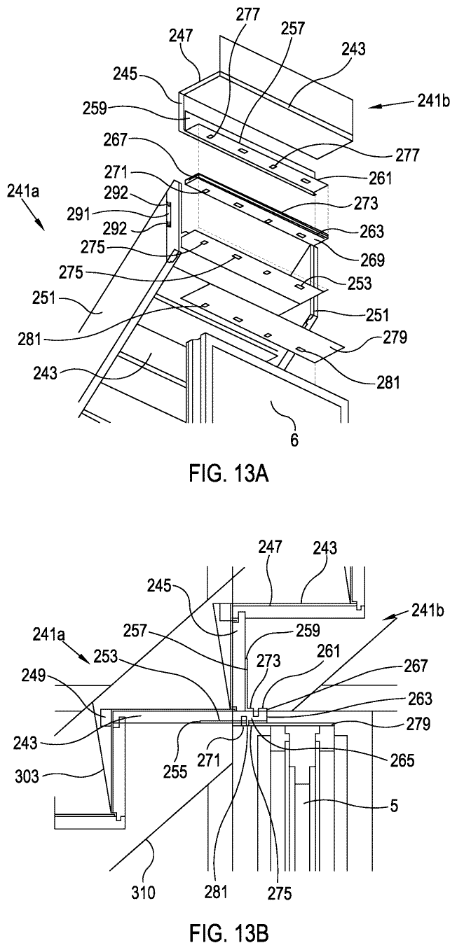

FIG. 13A illustrates a connection between staircase modules in the structure of FIG. 11, in exploded view;

FIG. 13B illustrates the assembled connection between staircase modules in cross section and connection to an internal wall module;

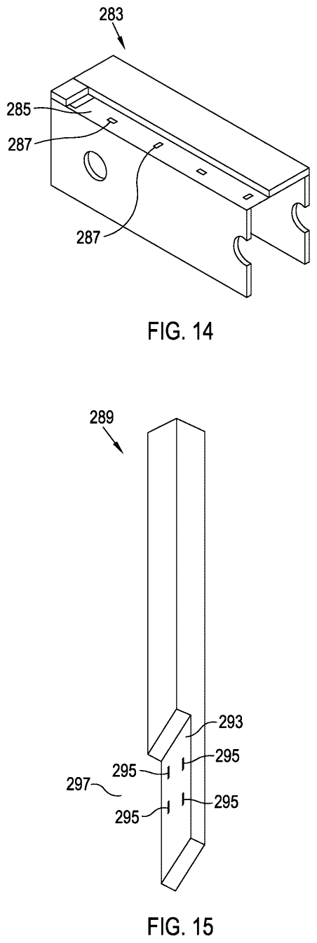

FIG. 14 illustrates a landing module for fitting the staircase to the floor in the structure of FIG. 11;

FIG. 15 illustrates an example of a vertical guarding and railing support for a staircase;

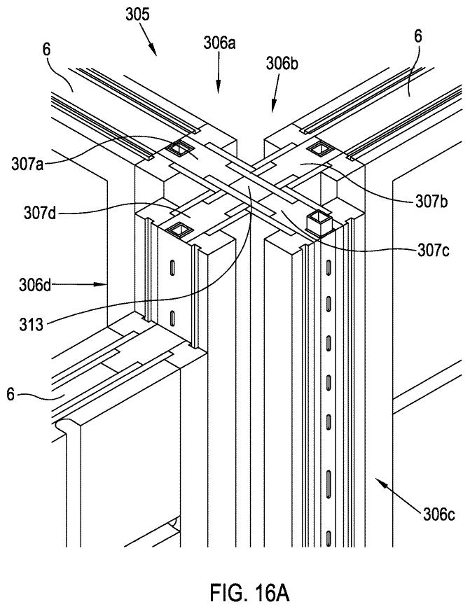

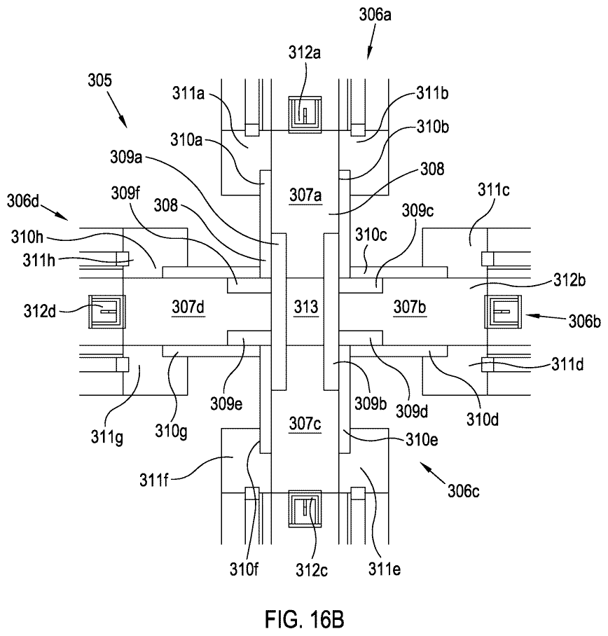

FIG. 16A illustrates a post for connecting four internal walls in a structure made using the modular building system according to an embodiment of the invention;

FIG. 16B illustrates the post of FIG. 16A in plan view;

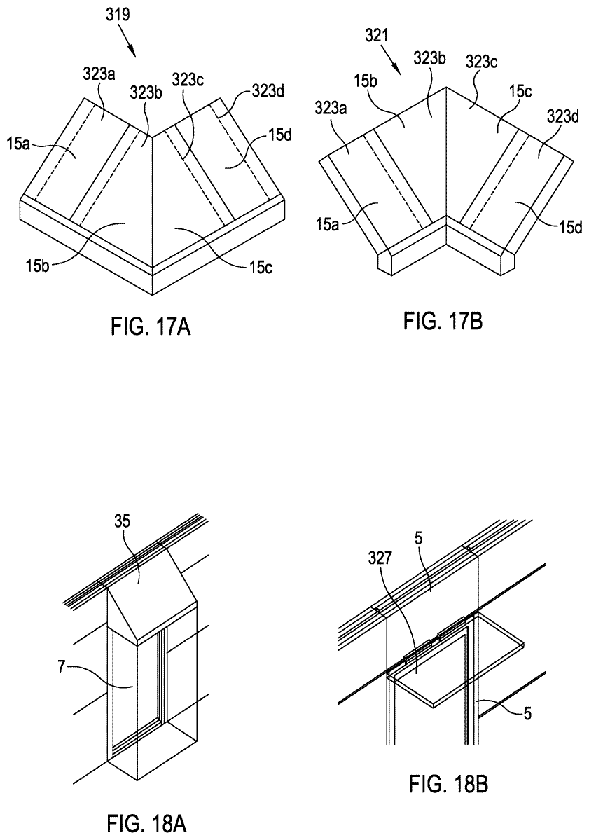

FIGS. 17A and 17B illustrate alternative roof modules from a modular building system according to an embodiment of the invention;

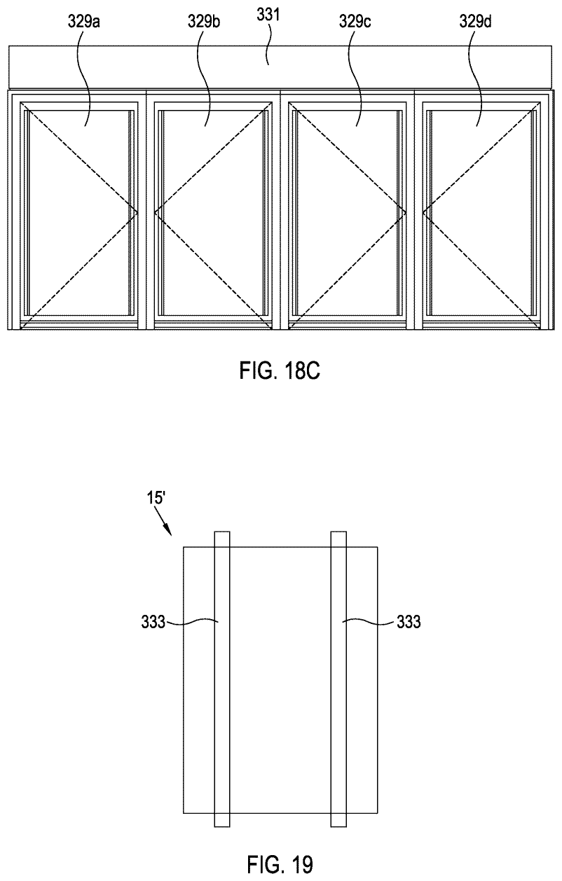

FIGS. 18A to 18B illustrate door modules with porches or canopies provided above them;

FIG. 18C illustrates a door that is several modules wide;

FIG. 19 illustrates a further alternative roof module from a modular building system according to an embodiment of the invention;

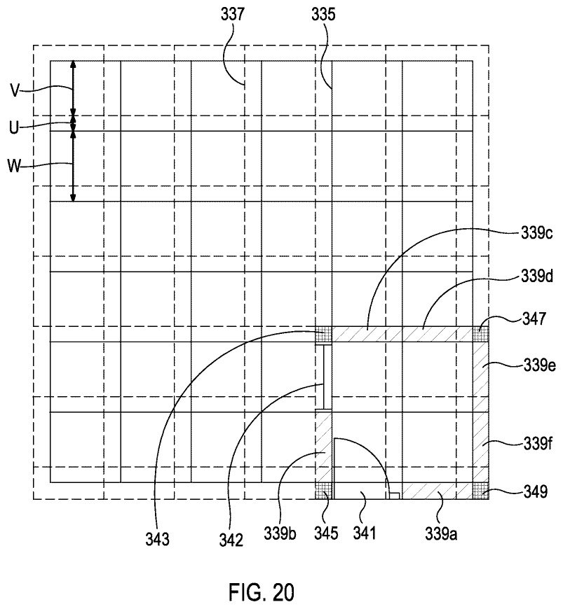

FIG. 20 illustrates a double grid system for designing a structure using a modular building system according to an embodiment of the invention;

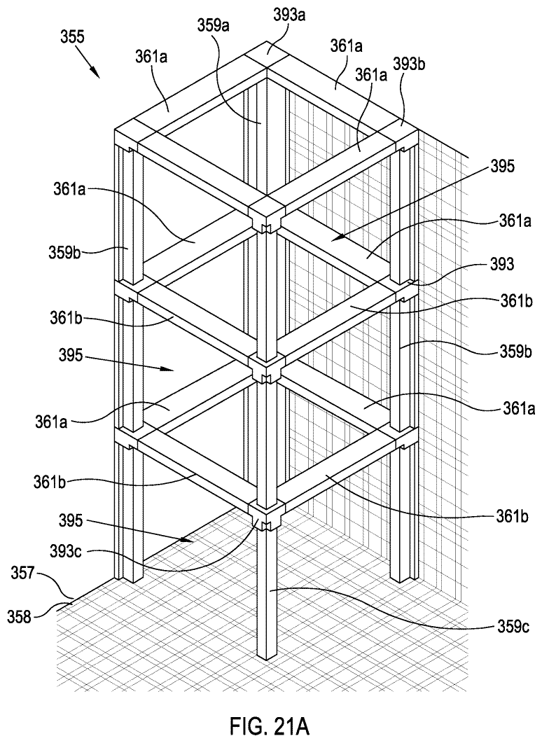

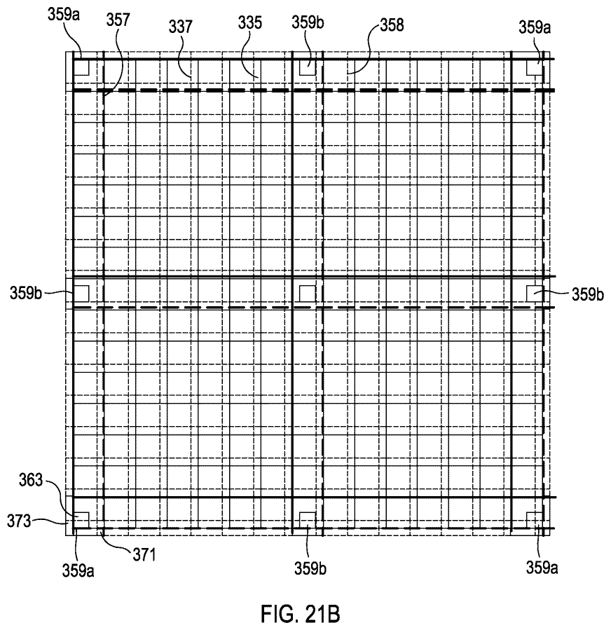

FIG. 21A illustrates a support frame for a structure over three stories tall, made using a modular building system according to an embodiment of the invention;

FIG. 21B illustrates the floor plan of the frame shown in FIG. 21A

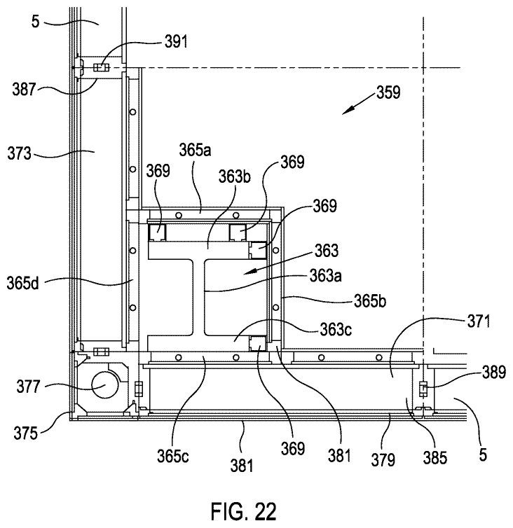

FIG. 22 illustrate a vertical corner support from the frame of FIG. 21 A;

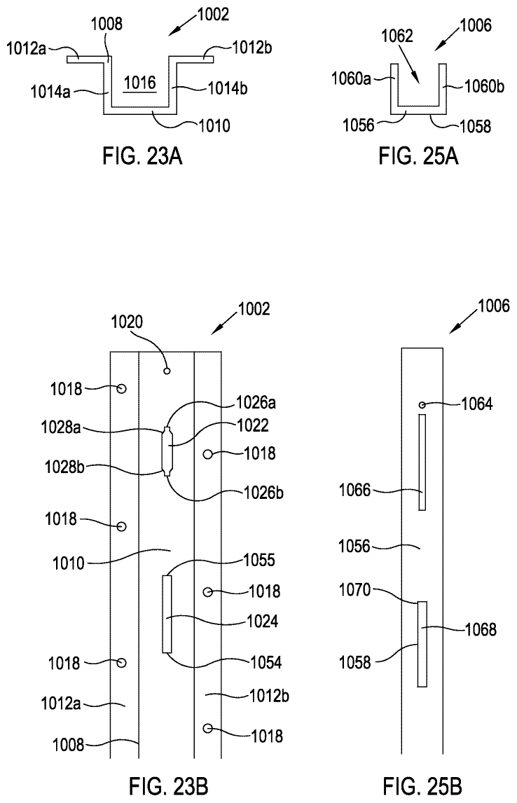

FIGS. 23A and 3B show a female member of an interlocking system for connecting modules of a modular building system according to an embodiment of the invention;

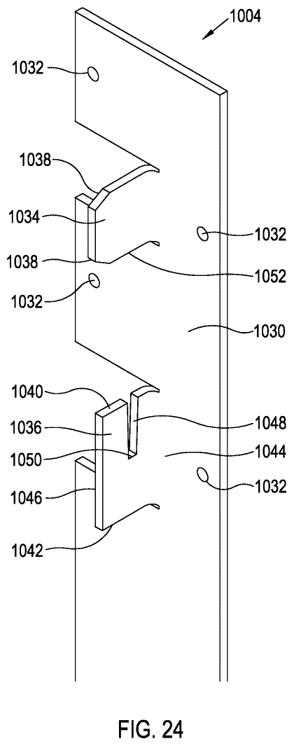

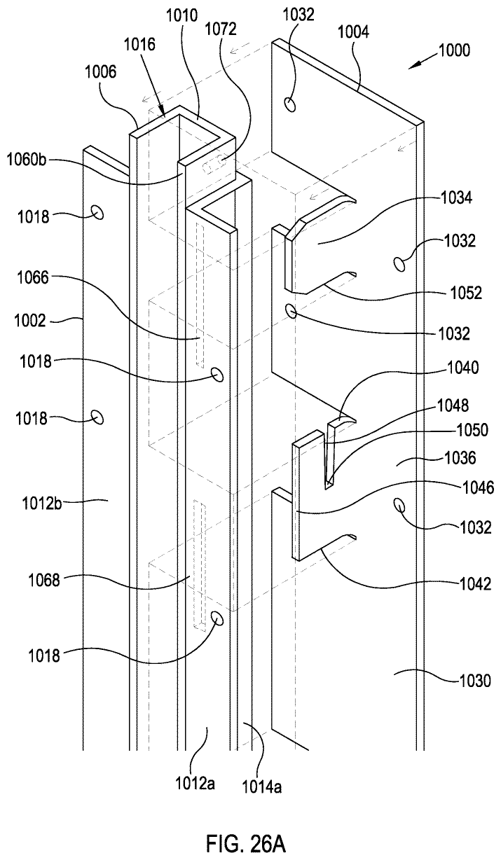

FIG. 24 shows a male member of an interlocking system for connecting modules of a modular building system according to an embodiment of the invention;

FIGS. 25A and 25B show a locking member of an interlocking system for connecting modules of a modular building system according to an embodiment of the invention; and

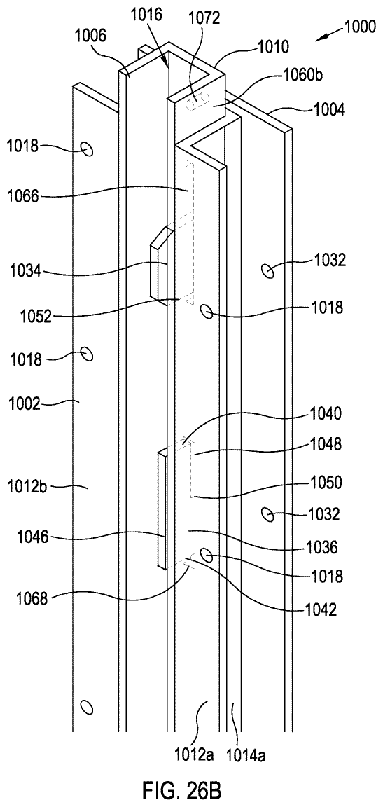

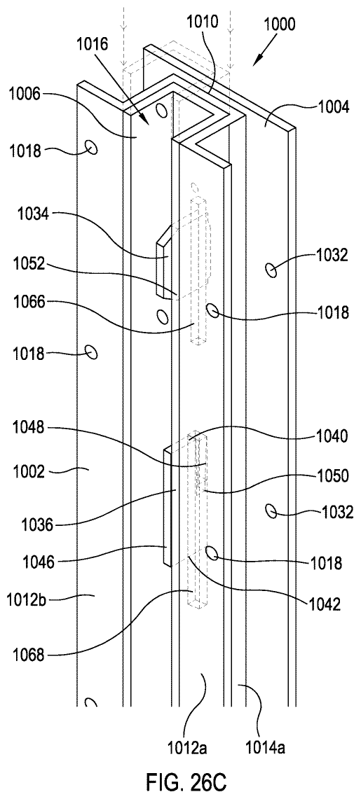

FIG. 26A to C illustrate the interlocking of the female member of FIGS. 23A-B with the male member of FIG. 24 and the locking member of FIGS. 25A-B.

FIG. 1 schematically illustrates an example of a structure 1 constructed using a modular building system of an example embodiment.

The structure 1 is formed of a number of different modules or panels 5, 5a, 7, 9, 11, 15, 16, 19, 21, 23, 25, 31, 223. The walls 3 of the structure 1 may be formed of panels or modules including, but not limited to, wall modules 5, 5a, a door module 7, a window module 9, and corner post modules 11. The door module 7 and window module define openings 7a, 9a extending through the thickness of the wall 3, for forming the door or window.

The roof 13 is a pitched roof made of roof modules 15 and a skylight module 16, which form an opening 16a in a similar fashion to the window module 9. The roof and skylight modules 15, 16 are joined at the ridge 17 of the roof 13 by ridge modules 19 and to the tops of the walls 3 by eaves modules 21. Along the gable edges of the roof 13, verge modules 23 are provided where the roof 13 meets the gables 29. Where the ridge modules 19, verge modules 23 and gables 29 meet, key modules 25 are provided. Where the eaves modules 21, and verge modules 23 meet, at the top corners of the walls 3, verge connector modules 27 are provided.

In the assembled structure 1, at least some of the wall modules 5a may be shaped to fit in a gable 29 of the roof 13. The exterior of the walls 3 of the structure is covered by cladding panels 31. In FIG. 1, the cladding panels 31 are only shown covering a portion of the walls 3, to allow the structure behind the cladding 31 to be seen.

The cladding panels 31 provide an exterior finish to the structure 1. In the example shown, the cladding panels 31 are the length as the modules 5, 5a, 7, 9 making the walls 3 (where the length is measured in a direction around the circumference of the building). The height of the cladding panels 31 shown is the same as the height of two modules 5, 5a, 7, 9 making the walls 3. Shaped cladding panels 31a may be provided in the eaves and the like. The roof 13 may also include cladding panels 31b to provide the desired exterior finish on the roof 13.

Whilst weatherproofing of the structure 1 is provided by the various modules 5, 5a, 7, 9, 11, 15,16, 19, 21, 23, 25, 27 in the structure 1, joins between the modules 5, 5a, 7, 9, 11, 15,16, 19, 21, 23, 25, 27 and joins between cladding panels 31 are offset form each other to provide further weatherproofing. For example, the cladding panels 31 may be offset by half the length of the panels 31.

It will be appreciated that the structure 1 discussed above is given by way of example only, to show the general concepts of the modular building system. The structure 1 can be made any size or any simple shape using the correct selection of the basic modules 5, 5a, 7, 9, 11, 15, 16, 19, 21, 23, 25, 27, 31, 223, shown in FIG. 1 and discussed below. The modules 5, 5a, 7, 9, 11, 15, 16, 19, 21, 23, 25, 27, 31, 223 can be used to define an outer, weather tight building envelope, and also to subdivide the space formed within the envelope (for example to form rooms). More complex shapes can be made using shaped modules that have the same basic structure as the modules 5, 5a, 7, 9, 11, 15, 16, 19, 21, 23, 25, 27, 31, 223 in the structure of FIG. 1.

The wall modules 5 will now be discussed in more detail with reference to FIGS. 2A and 2B. FIG. 2A shows one of the wall modules 5 in exploded view. FIG. 2B shows the assembled wall module 5 with a corner cut away to show the internal structure. The wall module 5 is substantially rectangular in shape, having a planar inner face 33 and a parallel planar outer face 35, separated by a thickness forming edge faces 45a-d. The edge faces 45a-d extend in planes perpendicular to the inner and outer faces 33, 35 of the module 5.

A first edge face 45a is formed on the upper edge of the module 5, a second edge face 45b is formed on the right hand side of the module 5, a third edge face 45c is formed on the lower edge and a fourth edge face 45d on the left hand side.

The first and third edge faces 45a,c extend parallel to each other, spaced apart by the height of the wall module 5 and the second and fourth edge faces 45b,d extend parallel to each other and perpendicular to the first 45a and third edge faces, spaced apart by the length/width of the wall module 5.

In the example illustrated, the wall module 5 includes a pair of structural frame elements 53, 55. The frames are substantially rectangular in shape, extending in planes parallel to the inner face 33 and outer face 35.

A first, inner, frame element 53 is provided on the inner side 33 of the wall module 5. The inner frame element 53 is made of tubing or bars arranged in a rectangle having a central opening 57. A second, outer, frame element 55, is provided on the outer side 35 of the wall module 5. Like the inner frame element 53, this is also made of tubing arranged in a rectangle defining a central opening 59.

The frame elements 53, 55 may be made of the same material as each other, or different material. Optionally, one or both of the frame elements 53, 55 may be load bearing. By way of example, the frame elements 53, 55 may be made of aluminium extrusion of 50 mm thickness, with a substantially square cross section.

The inner frame element 53 and outer frame element 55 are spaced from each other to form the correct thickness of the wall module 5. On each of the edge faces 45a-d, edge members 47a-d are provided, extending between the frame elements 53, 55 and forming the sides of the wall module 5. The edge members 47a-d, when secured together, form a substantially rectangular central frame element 47 having an open space 39 in the centre. The edge faces 45a-d of the module are thus made up of a combination of the edge members 47a-d and frame elements 53, 55.

The edge members 47a-d are made of wood or other suitable material.

Each edge member 47a-d has a width extending between the frame elements 53, 55 from an inner side 48c that abuts the inner frame element 53 and a parallel outer side 48d that abuts the outer frame element 55. Each edge member also has a length extending along the edge face 45a-d of the wall module 5 and a thickness extending perpendicular to the length and width. The thickness extends between an interior face 48a facing extending perpendicular to the inner face 33 and outer face 35 of the module and facing into the volume 39, and an exterior face 48b parallel to the interior face 48a and facing out of the edge of the wall module 5.

The inner and outer frame elements 53, 55 are secured to the edge members 47a-d by mechanical fixings such as bolts or screws. The edge members 47a-d are secured together by similar means to form a central frame 47. An adhesive may be used as well as or instead of the mechanical fixings.

The inset of FIG. 2B shows a simplified cross section of the top edge member 47a in more detail. Unless stated otherwise, each of the four edge members 47a-d have the same cross-section.

On its inner side 48c, the edge member 47a includes a stepped portion 49. The stepped portion 49 is arranged such that the edge member 47a is wider at its exterior face 48b than its interior face 48a. The thickness of the tubing forming the inner frame element 53 is greater than the thickness of the wider part of the stepped portion 49. A first inner layer 63 of the wall module 5 is retained between the inner frame element 53 and the narrower part of the edge member 47a on the interior side of the stepped portion 49. The first inner layer 63 is a structural layer which may be, for example, 18 mm oriented strand board.

The tubing forming the inner frame element 53 also includes a rebate 65 on the corner facing into the interior of the module 5, adjacent the interior face 48a of the edge member 47a. A second inner layer 67, in the form of a fire protection layer, such as 9 mm calcium silicate fire board is provide, retained between the first inner layer 63 and the rebate 65.

As best shown in FIG. 2B, a vapour seal 69 may be provided between the load bearing layer 63 and fire protection layer 67 to provide a water tight seal in the structure of the panel.

Within the opening 57 in the inner frame 53 a service layer 71 is provided. This may be, for example, 40 mm polyurethane foam. The inner face of the service layer 71 is flush with the inner face 85 of the inner frame 53, so the inner face of the wall module 5 is formed by the service layer 71 and inner frame 53.

The service layer 71 includes channels 73 which are open onto the inner face 33 of the wall module 5. These channels 73 allow for provision of conduits 75 such as, for example, electricity supply, water supply, gas supply, or any other required services. In the example shown, the channels 73 are formed as recesses in the surface of the service layer 71. In other examples, the channels 75 may be formed within the service layer 71, so they are only open at the top and bottom of the module 5, and are not open onto the inner face 33. The services layer also include larger recesses 77 for pattress boxes and other larger fittings that should be hidden within the structure of the wall 3.

The inner frame element 53 includes apertures 79 on its vertical and horizontal edges to allow for the conduits 75 to be passed between adjacent modules 5.

The tubing forming the outer frame element 55 is substantially “T” shaped in cross section, having a narrow base portion facing into the opening 59 in the frame element 55, and a wider top portion, forming the edge 45a-d of the module 5.

A rebate 61 is formed at the corner of the edge member 47a-d between the exterior face 48b and the outer side 48d (i.e. on the outer most corner). One side of the wider top portion of the T shaped cross section of the outer frame element 55 is located in this rebate 61.

A first outer layer 81 is provided in the opening 59 of the outer frame element. This is a further structural layer. This layer may be, for example, 11 mm oriented strand board. A second outer layer 83, in the form of a waterproof layer, such as 12 mm epoxy recycled plastic is provided on the outer side of the first outer layer 81. This is located by the wider top portion of the outer frame element 55. The second outer layer 83 may provide, for example, weather proofing of the wall module 5. The outer waterproof layer 83 is flush with the outer face 87 of the outer frame 55, and so the outer face 35 of the wall module 35 is provided by the waterproof layer 83 and the outer frame 55.

It will be appreciated that the interior face 48a of the edge members 47a-d may be formed with further recesses to locate the different layers 63, 67, 71, 81, 83 forming the modules.

The edge members 47a-d, first inner layer 63 and first outer layer 81 define a substantially cuboid volume 39 at the centre of the module 5. This is filled with an insulating material 38, such as foam, to provide a thermal barrier in the module 5. This foam forms a core layer 37 of the module 5. For example, this may be polyisocyanurate foam or other materials.

The insulating material 38 is introduced into the module 5 as a liquid which expands in the volume 39. In addition to forming the core layer 37, as the liquid expands, it bonds or connects to the first inner layer 63 and first outer layer 81, the edge members 47a-d, and outer frame 55 together. Furthermore, this urges the other layers into their seats formed in the frame member 47, 53, 55 to hold them securely in place.

In one example, one or more of the edge members 47a-d may each include one or more apertures 41 to allow filling of the volume 39 once the frames 53, 55, 47 and layers 63, 67, 71, 81, 83 are assembled. The apertures 41 may be formed in a groove 42 on the edge member 47a-d, which is closed with a filling member 43 after the volume is filled. In the example shown, the top edge member 47a includes the apertures 41. The other edge members 47b-d do not include aperture 41.

As best shown in FIG. 2B, the top edge member 47a may include a projection extending out of the exterior face 48b. In the example shown, this is formed by the filling member 43. The bottom edge member 47c may include a corresponding groove in its exterior face to locate two vertically adjacent modules relative to each other. The bottom edge member 47c may also include a recessed region to receive the support rail 91.

The side edge members 47b,d may have a planar exterior face 48b, which allows engagement members, as will be discussed below, to be secured to the modules. Alternatively, the engagement members may be secured in a groove or onto a projection extending from the side edge members 47b,d. In yet further examples, the side edge members 47b,d may be provided with interengaging projections and grooves, in a similar manner to the top and bottom edge members 47a,c.

Use of expanding foam also ensures the module 5 is light weight. Furthermore, the foam may mean the volume can be quickly filled during manufacture of the module. For example, 10 kg of liquid may be needed to fill a void of 200 litres. This may only take approximately 10 seconds to fill.

As will be discussed in more detail below, engagement elements may be mounted to at least the vertically extending edge members 47b,d, to provide for a means to interlock each module 5 to an adjacent module, horizontally.

To allow connection of interior finish layers and furniture, the inner face 85 of the inner frame 53 include connection or hanger points 89, as will be discussed in more detail below.

To allow connection of exterior cladding panels 31, the outer face 35 of the wall module 5 includes a support rail 91 at a lower edge of the frame. This will also be discussed in more detail below. As best shown in FIG. 2B, this is fixed to the underside of the outer frame 55, flush with the bottom of the wall module 5. This may be fixed by adhesive, mechanical fixing or any other method. The connection of cladding 31 to the structure 1 will be discussed in more detail below.

To ensure the structure 1 is weather tight, weather proof seals 93 are provided on the edges of the outer frame 55. These form weather tight seals to adjacent modules 5. The seals 93 may be made of any suitable sealing material, such as rubber. Seals may also be formed in the inner frame 53 to ensure the structure 1 is air tight.

Although the example discussed above is a rectangular wall module 5, it will be appreciated that a wall module 5 may be made any shape having the layered composite structure discussed above For example, a wall module 5a may be provided to fit in the gable end 29 of the structure 1.

It will further be appreciated that other modules, away from corners, vertices or joins may also have a similar structure. For example a roof module 15 may have the same structure as the wall module 5. Similarly, door and window modules 7, 9 (and skylight modules 16) may also have the same structure, away from the openings 7a, 9a, 16a.

The wall module 5 discussed above is an exterior wall module for making a wall on the exterior perimeter of the structure 1 (defining a building envelope). Internal walls within the structure 1 may be formed by wall modules 5 having a different structure to external wall modules 5. For example, internal frame elements 53 may be provided on both sides of the module, with internal structural layers 63, fire protection layers 67 and service layers 71. Some or all of these layers may be omitted on one side of the module 5. Alternatively, the internal wall modules may have a similar structure to the external wall modules. For example, this may be used at party walls.

FIGS. 3A and 3B show an example of a door module 7 in perspective view and cross-sectional view respectively (showing the full height of the door), whilst FIG. 4 shows an example of a window module 9.

In the example illustrated, the door or window (or another type of opening) occupies the substantially the full area of the module 7, 9. In this case, the module 7, 9 includes an inner frame element 53, an outer frame element 55 and a central frame 47 in a similar fashion to the wall module 5. The opening 7a, 9a for the door or frame is formed by the openings in the frame elements 47, 53, 55.

As best shown in FIG. 3B, the door frame 97 or window frame 99 is secured to the inner side of the central frame 47. The door frame 97, or window frame 99 in turn holds in the door panel 101 or transparent window panel 103. Optionally, an engagement element may be provided on the inner side of the central frame 47 to secure the door frame 97 or window frame 99.

Seals 105 and weathering trims 107 may be provided as part of the door module 7 or window module 9 to ensure the module retains remain weather tight.

In the above example, the door or window opening 7a, 9a occupies substantially all of the surface area of the module 7, 9 (as defined by the frames 53, 55). In other examples, this may not be the case. Where the opening 7a, 9a is only a portion of the surface area of the module, the module 7, 9 may be based on a wall module 5, as discussed above, with an opening formed therethrough. In this case, An inner frame (not shown) might be provided to define the boundary of the opening 7a, 9a and form the enclosed area that is filled by the foam 38.

For doors or windows where a level threshold is desired, part or all of the frame elements 47, 53, 55 may be omitted. For example, the frame may be an inverted U, with no frame along the bottom of the module 7, 9. Furthermore, where a module is used to make part of an opening extending over the area of several modules, the frame elements 47, 53, 55 may be omitted at an edge which is within the area of the desired opening.

The structure 1 of FIG. 1 is mostly made of wall modules 5 modules, door modules 7, window modules 9, and roof modules 15 as discussed above. The wall modules 5 modules, door modules 7, window modules 9 all interconnect using the same interlocking system. Therefore, these modules 5, 7, 9 can all connect to each other in a wall 3 with no further modules.

In the example shown in FIG. 1, post modules 11 are provided at corners in the walls 3, to provide connection through the change in direction. FIGS. 5A and 5B show examples of corner posts 11a, 11b. In FIG. 5A, the corner post 11a is an external corner post, of the type used at the four corners of the structure 1 in FIG. 1. In FIG. 5B, the corner post 11b is an internal corner post. In both cases, the post 11a, 11b has four sides but only two visible in the structure (the remaining two sides engaging wall modules 5). In external post modules 11a, the visible sides are on the outside of the structure 1, whilst for internal post modules 11b, the visible sides are on the outside of the structure 1.

In a similar manner to the wall module 5, the post modules 11a, 11b include an inner frame element 53 and an outer frame element 55. In the external corner post 11a, the outer frame element 55 has a 90 degree bend 109a splitting the outer face 35 of the module into two faces 35a, 35b at 90 degrees to each other, and a vertical element 108a at the corner 109a. The inner frame element 53 is a vertical bar forming the corner 109b of the post diagonally opposite to the bend 109a in the outer frame element 55.

As shown in FIG. 5A, the external corner post 11a is substantially square in top down view, having four faces. As discussed above, two external faces 35a, 35b are formed by the outer frame element 55. The remaining two faces 111a, 111b are formed by edge members 47b, 47d as discussed in relation to the wall module 5. The edge members 47b, 47d may also have engagement elements as discussed above. As in the wall module 5, edge members 47a, 47c are also provided on the top and bottom of the post 11a.

The inside structure of the post module 11a is similar to the inside structure of the wall modules. Due to the corner, the inner layers 61, 63 and service layer 71 are omitted on the post 11a. Furthermore, the outer layers 81, 83 are formed of two separate sheets provided in the separate faces of the outer frame element 55, which are split by the vertical post 108a. In the case of the exterior post 11a, the volume within the post is defined by the edge members 47a-d, and the two perpendicular parts of the first outer layer 81. The volume in the post 11a is filled with the same insulating material as the wall module 5 through apertures (not shown) in the top edge member 47a in a similar manner to the wall module 5.

Location pins 78 are provided on the top face of the post 11a. These are used to locate the post vertically to apertures (not shown) in a post or module above. The pins 78 are provided at the corner 109a in the outer face 35 and the diagonally opposite corner.

Apertures 79 are provided in the vertical post forming the inner frame member 53, to allow for passage of services and the like between wall modules 5 connected to either side of the post 11a.

The interior corner post 11b, shown in FIG. 5B, is of similar construction to the exterior corner post 11a. However, in the interior corner post 11b, the inner frame element 53 is formed with a 90 degree bend 109b and an additional vertical member 108b splitting the inner face 33 of the module 11b into two portions 33a, 33b, whilst the exterior frame element 55 is a single vertical post at the corner diagonally opposite the bend in the inner frame element 53.

As with the exterior post module 11a, the interior post module 11b is substantially square in top down cross section, with two internal faces 33a, 33b formed by the internal frame element 53, and the remaining two faces 113a, 113b formed by edge member 47b, 47c. Edge member 47a, 47b are also provided on the top and bottom of the interior post 11b.

In the interior post module 11b, the outer layers 81, 83 are omitted from the module structure. However, the first and second inner layers 63, 67 and service layer 71 are provided. The inner layers 63, 67 may have a bend, or may be made of two planar sheets arranged at angles to each other, parallel to the corresponding faces 33a, 33b of the post module 11b. The service layer 71 is made up of two parts received in the two faces of the inner frame module 53, which are separated by the vertical member 108b.

The internal volume of the interior post module 11b is formed between the edge members 47a-d and the first inner layer 63. As with the wall module 5 and the exterior post module 11a, the interior post module 11a is filled with the same insulating material as the wall module 5 through apertures (not shown) in the top edge member 47a in a similar manner to the wall module 5.

The services layer 71 in the interior post module 11b is formed with channels 73 for carrying services. Openings 79 are also formed in the inner frame element 53, including the extra vertical bar 108b to allow connectivity of the channels 73 to channels in adjacent modules.

In FIGS. 5A and 5B, the post module is for joining walls 3 at a corner. It will, however, be appreciated that in some instances, the post module may be for joining two parallel wall modules 5 in a continuous planar wall. In this case, the post module 11 may simply be considered the same as a wall module 5 of reduce length so that it is substantially square in top view. This will contain all of the same layers as the wall module 5.

In the example of the exterior post 11a shown in FIG. 5A, a conduit 115 is formed extending vertically down the post 11a. This can be used to remove waste from the structure 1. The post conduit 115 is optional and may be omitted. Instead, only conduits 75 in wall modules 5 may be used, or some conduits may be provided as external fixtures. Alternatively, a conduit 115 may be provided in either exterior 11a or interior 11b posts, or a post module that joins two parallel wall modules 5.

Where a post module 11 includes a conduit 115, a pipe or cylinder is provided through the module 11 before it is filled with the foam 38. This is held in place by the edge members 47a, 47d on the top and bottom of the post module 11a, 11b which include collars or the like for holding the pipe. Therefore, the pipe restricts the foam from expanding into areas it is not needed.

The pipe and/or post modules may include seals and connectors to allow connection to vertically adjacent conduits 115.

An alternative embodiment for forming corners is shown in FIG. 6. In this example, the corner is integrated into the wall module 5.

In the wall module 5 shown in FIGS. 2A and 2B, the inner frame element 53 and outer frame element 55 are the same shape and size, and fully overlie each other in the plane of the wall 3. This is not the case in the wall module 5 shown in FIG. 6. In the wall module shown in FIG. 6, the inner frame element 33 is a simple rectangle as in the wall module 5 in FIGS. 2A and 2B. However, the outer frame element 55 includes a bend 119 in a similar manner to the corner posts 11a, 11b.

As shown in FIG. 6, the top and bottom edges of the outer frame element 55 align with the top and bottom edges of the inner frame element 53 to form the top and bottom edges 45a, 45c of the module 5. Furthermore, a first end of the inner and outer frame elements 53, 55 align to form one of the side edges 45b. However, at the opposite end of the module 5, the outer frame extends past the inner frame 53, and then turns a corner 119 to extend over the gap between the inner frame element 53 and outer frame element 55. The outer frame element 55 then ends in the same plane as the inner frame element 53, such that the inner face 33 of the module 5 is still flat.

In the module 5 shown in FIG. 6, the gap between the inner frame element 53 and outer frame element 55 is “L” shaped when viewed from above. The outer frame element 55 includes an additional vertical post (not shown) at the corner. The top and bottom edge member 47a, 47c include a right angle corner so that the follow the “L” shaped gap on the top and bottom.

At the first side of the module 5, where the inner and outer frame elements 53, 55 are aligned, the edge member 47b is provided facing out of the edge face 45b, as in the module 5 in FIGS. 2A and 2B. However, at the second side of the module, the edge member 47d is arranged on the inner face of the wall module 45, in the same plane as the inner frame. As discussed above, the edge members 47b, 47d on both sides may include engagement elements for connecting adjacent modules 5. There fore, the module 5 in FIG. 6 allows a corner to be formed.

In the module shown in FIG. 6, the inner layers 63, 67 and service layer 71 are planar rectangles, the same as in the module 5 shown in FIG. 2A. However, the outer layers 81, 83, which are received in the opening are formed with a corner, by two separate planar sheets in the parts of the frame separate by the additional vertical member. Therefore, the edge face 45d on the second side of the module 5 is formed by the second outer layer 83, and not an edge member 47d. A filler member 120 is provided between the inner frame 53 and the edge member 47d facing on the inner face 33.

The volume in the middle of the module 5, which is filled by the insulating material 38 to form a core layer 37 is also “L” shaped. This is filled in the same manner as the wall module 5 shown in FIGS. 2A and 2B. Location pins 78 are also provided at the corner, in a similar manner to the corner posts 11a, 11b.

Optionally, a tie member (not shown) may extend between the inner frame 53 and outer frame 55, from the end of the inner frame 53 at which the corner is formed. The tie may extend perpendicular to the inner and outer faces 33, 35. The tie may be made of aluminium or another material and provides rigidity. The tie may extend the full height of the module 5, or part of the height of the module. Alternatively, a plurality of ties may be provided at different heights, with spaces therebetween. In the example where the tie extends the full height, this may split the internal volume into two areas which need to be filled with foam 38 separately. In the other cases, the inner volume is still a single zone. Alternatively, the tie may have openings such that the volume is effectively a single zone.

It will be appreciated that using the wall module 5′ shown in FIG. 6, an exterior corner can be made without requiring a separate post module 11. Furthermore, it will be appreciated that an interior corner can be made using similar techniques, but making the interior frame element 53a extend beyond the outer frame element 55 and turn a corner over the edge 45d of the module 5, rather than the outer frame element 55.

The arrangement of the roof 13 of the structure of FIG. 1 will now be described with reference to FIGS. 7 and 8.

FIG. 7 illustrates the arrangement of a section of the roof 13 in exploded view at a gable end of the roof 13. The illustrated section has a single roof module 15 as discussed above. At the ridge 17 of the roof 13, a ridge module 19 is provided to join the top 121a of the roof module 15 on one side of the roof 13 to a roof module 15 on the other side of the roof 13. This is similar in construction to the post modules 11. However, the angle between the adjacent faces of the ridge module 19 is different to the post 11 used in the wall 3 to ensure the correct pitch in the roof 13.

Along one side 121b, the roof module 15 may join to an adjacent roof module 15, in a similar manner to the join between wall modules 15. At the opposite side 121c of the roof module 15, adjacent the gable end of the structure 1, the roof module 15 joins to a verge module 23. Again, this is similar in arrangement to the post module 11, to join the roof module 15 to the top of the gable wall modules 5a.

At the bottom 121d of the roof module 15, the roof 13 is coupled to the wall 3 through an eaves module 21. FIG. 8 illustrates the eaves module 21 in more detail.

The eaves module 21 has a planar lower face 125a facing downwards. In the assembled structure 1, the planar lower face 125a extends parallel to the top edge of a wall 3.

The eaves module 21 also has a substantially planar upper face 125b extending parallel to the lower face 125a, and spaced above the lower face 125a.

Extending between the lower face 125a and upper face 125b are an inner face 125c and an opposing outer face 125d. The inner face 125c and outer face 125d are substantially parallel to each other and perpendicular to the lower face 125a and upper face 125b. in the assembled structure 1, the inner face 125c faces into the inside of the structure 1, and the outer face 125d faces out.

A first edge member 127 is provided on the planar lower face 125a. The first edge member has an engagement element, such as a shaped projection or recess, for connection to the top of the wall modules 5.

A first inner frame element 151a is provided at the corner between the lower face 125a and the inner face 125c of the module 21. The first inner frame element 151a is in the form of a bar extending along the length of the eaves module 21, having a lower surface flush with the lower surface of the first edge member 127.

A second inner frame element 151b is provided at the upper end of the inner face 125c. The second inner frame element is also in the form of a bar extending along the length of the eaves module 21. When viewed end on, the second inner frame element 151b is inclined with respect to the first inner frame element 151a. The first inner frame element has upper and lower surfaces perpendicular to the inner face 125c of the eaves module, and sided parallel to the inner face 125c. On the other hand, the second inner frame element 151b is rotated such that the upper face of the second inner frame element is parallel to the direction of the roof 13.

An inner structural layer 153 is provided along the inner face 125c of the eaves module 21. The structural layer 153 extends between a recess 155 formed in the second inner frame element 151b and a locating steps 157a,b formed in the first edge member 127 and first inner frame element 151a. An internal fires resistant layer (not shown) may be provided on the inner side of the inner structural layer 153.

A first outer frame element 131 is provided parallel to the second inner frame element 151b. The first outer frame element 131 is an elongate bar extending along the length the eaves module, It is spaced above the second inner frame element 151b, and towards the outer face 125d of the eaves module 21. The first outer frame element 131 is positioned above the upper face 125b of the eaves module 21.

In the space between the second inner frame element 151b and the first outer frame element 131, a second edge member 135 is provided. This is arranged to couple the eaves module 21 to a roof modules 15. The second edge member 135 is thus parallel to the lower end of the roof module 121d to form an interface to the roof modules. The interface between the eaves module 21 and the lower end of the roof module 121d may be the same as the interface between other wall modules.

An outer weather proofing layer 143 is provided on the outside of the second frame, extending in the same plane as the roof 15, perpendicular to the second edge member 135, and extending below the edge member 135 This layer 143 may be the same as the second outer layer 83 in the wall module 5.

A second outer frame element 171 is provided on the outer face 125d of the eaves module 21, at the corner near the outer face 125d and lower face 125a. The first edge member 127 is received between the first inner frame element 151a and the second outer frame element 171.

The inner structural layer 153 may be made of the same material as the structural layer 63, 81 in the wall module 5.

The facing layer 159 defines a shaped profile portion 163 that defines a facia of the eaves of the structure 1. A part of the facing layer and the outer structural layer 158 are spaced from each other, and joined at the top to define a closed recess 167 defining the soffit and for receiving the top of a cladding panel 31, as will be discussed in more detail below.

The shaped profile portion 163 extends above the top surface 125b of the eaves module 21. The facing layer 159 include a gutter profile portion 165 extending down from the shaped profile portion 163, across the top surface 125b of the eaves module 21 and then up, at an incline back over the top surface 125b to the first outer frame element 131 outer weather proofing layer 143. The gutter profile portion 165 defines a channel 169 for collecting rainwater from the roof 13.

The facing layer 159 may be made of aluminium, UPVC or any other suitable material.

Similarly to the wall modules 5, the eaves module 21 includes a support rail 173 secured to the low end of the second water proofing layer 170 and second outer frame element 171 on the outer surface 125d of the eaves module 21. This extends to overlap a portion of the edge member 127, in a recess 175 in the edge member 127.

As with the wall module 5, an internal volume 123 is defined inside the eaves module 21. In the eaves module 21, this is defined by the frame elements 131, 151a, 151b, 171, the edge members 127, 135, structural layers 153, 158 weather proofing layers 143, 170 and facing layer 159.

The volume 123 has a central section that is substantially square in cross section, and elongate such that it extends along a top of a wall 3. Along the length of the eaves module 21, the volume 123 also includes a projection 123b extending from the corner between the upper face 125b and the inner face 125c. This defines a further volume between the second edge member 135, the second inner frame element 151b and the first outer frame element 131.

The projection 129 has a first inclined surface 137a facing towards the roof module, defined by the second edge member 135. The first inclined surface 137a extends parallel to the bottom edge 121d of the roof module 15 in the assembled structure 1.

Spaced from and parallel to the first inclined surface 137a, the projection includes a second inclined surface 137b, extending over and facing the top face 125b of the eaves module 21. This is defined by the facing layer 159.

The projection 123b is joined to the central portion 123a of the volume by a neck 133.

As in the wall module 5, the volume 123 in the eaves module 21 is filled with an expanding insulating foam, through apertures in the second edge member 135.

At the lower corners of the roof 13, verge connector modules 27 are provided. These are corner elements that connect the verge modules 23 to the eaves modules 21. In construction, they are similar to the eaves modules 21. However, an end 179 of the gutter channel 169 is closed and the length is reduced so they simply form a corner. An opening (not shown) is formed so the gutter channel 169 can drain into a waste conduit 115 formed in a post 11.

Alternatively, eaves modules 21 may have integrated connectors to form the ends of the eaves.

It will be appreciated that the verge connector modules 27 and/or eaves 21 with integrated connectors may have left hand and right hand configurations. Further configurations will also be appreciated for gullies and valleys.

In some examples, roof modules 15 may be arranged to overlap the modules either side of them, and the roof module 15 or eaves module 21 below the. In addition, sealing elements (such as neoprene sealing elements) may be provided.

It will be appreciated that a flat roof, or a single pitch roof may be formed by use of eaves modules 21 with correctly selected angles.

As discussed above, the wall modules 5, door module 7, window modules 9, post modules 11, roof modules 15, eaves modules 21, verge modules 23, key modules 25 and verge connector modules 27 all include one or more structural frame elements 47, 53, 55, 151, 171. Each of these frames 47, 53, 55, 151, 171 is arranged to be load bearing in the assembled structure. Furthermore, each of the modules 5, 7, 9 ,11, 15, 21, 23, 25, 27 is arranged such that the frames of adjacent modules (horizontally or vertically) align. Therefore, in the assembled structure 1, the weight and load of the building is distributed through the frame elements 47, 53, 55, 151, 171 of the modules 5, 7, 9 ,11, 15, 21, 23, 25, 27 without any need for a separate support frame or structure.

Once the modules are assembled into the structure 1, the cladding panels 31 may be fixed to the exterior of the structure 1. Cladding panels 31 may be provided on both the walls 3 and roof 13, and can be used to provide any desired aesthetic appearance to the structure. Furthermore, the cladding panels 31 may provide certain functions, such as photovoltaic cells. In this way, the photovoltaic cells may be made flush with the other non-functional cladding panels 31.

FIGS. 9A and 9B show the cladding system in more detail. FIG. 9A shows a cross section through a wall 3 having three vertically stacked wall modules 5a, 5b, 5c and two vertically stacked cladding panels 31a, 31b on the exterior. FIG. 9B shows the region around the join between the two lower wall modules 5a, 5b in more detail.

As discussed above, each wall module 5a-c has a support rail 91 provided on the lower edge on the exterior of the module 5a-c. This extends horizontally along some or all of the length of the module 5a-c. The support rails 91a-c extend out from the outer face 35 of the module 5 and may include an upturned portion 185 spaced away from the front face 35 of the module 5.

The cladding panels 31a-b are formed of a sheet of any suitable material having an exterior (front) face 181 and an interior (rear) face 183. Vertically extending support rails 187 may be secured to the rear face 183 at regular intervals along the cladding panels 31a-b. Mounting brackets 189 are then fixed to the vertical rails 187 at the same vertical positions as the horizontal support rails 91. Alternatively, the brackets 189 may be fitted directly to the cladding panels 31, depending on the material of the cladding panels 3. The brackets 189 may only extend for a short length of the panel 31.

Each support bracket 189 has a first bracket portion 191 which has a downward facing recess 193 arranged to hook onto the support rails 91a-c and form a rigid connection between the bracket 189 and the wall modules 5a-c. A second bracket portion 195 is rigidly fixed to the support rails 187 or cladding panels 31a-c by any suitable means. The two bracket portions 189, 195 are rigidly secured together, although there may be some freedom of movement between the two portions to allow for expansion and contraction. Alternatively, the material of the bracket may be allowed to allow for some flexing, or the fit of the bracket to the support rail may allow for expansion and contraction.

An opening 197 is provided in the support bracket 189. This may be used for fixing a support pin to secure a scaffold board, or other temporary structures.

In some examples, the bracket portions 189, 195 may be secured together by a pivot to provide some tolerance in the positioning of the panels 31a-c during installation, and/or flexing once installed.

FIG. 9C shows the engagement of the cladding panels 31 with an eaves module 21. In a similar manner to the engagement with the wall module 5, a bracket 189 is provided near the top 199 of the cladding panel 31 on the rear face 183. The bracket 189 hooks over the upturn 201 in the support rail 173 to hold the cladding panel 31 in place.

The second portion 195 of the bracket 189 includes a bottom bracing portion 195a that, extends below the recess 193. Therefore, when the panel 31a-c is fixed into place, the bracing portion 195a extends below the support rail 91a-c, spaced from the support rail 91a-c. The panel 31 can be locked in to place by providing a pin or other filler member (not shown) in the gap between the bracing portion 195a and the support rail 91a-c. This prevents the first bracket portion 189 lifting off the support rail 91a-c. Locking the panel 31a-c into place prevents the cladding panel 31 becoming dislodged in high winds or other conditions that may cause movement of the panel 31.

At the top 199 of the cladding panel 31, a gap 203 is created. The gap 203 may extend above the cladding panel 31 to provide ventilation to the void behind the cladding panel 31. The fascia 159 projects over and in front of the top of the cladding panel 31 to provide weather protection to the top surface of the cladding panel 31.

The height of the recess 167 in the eaves module 21 is such that during installation of the cladding panel 31, the panel 31 can be vertically slid upwards to allow the panels 31 and brackets 189 to be slid over the support rails 91, 173. This also allows for ventilation of the rear side of the cladding panel, in the assembled structure 1.

Internally, the hanger points 89 in the inner frame 53 of the wall modules 5 are used to support internal cladding panels (not shown). The hanger points 89 comprise slots opening into the profile of the frame 53. As shown in FIGS. 2A and 2B, the hanger points 89 are regularly spaced around the inner frame 53.

The internal cladding panels may include, for example, coving and skirting boards, and apertures lined up with pattress boxes in the service layer 71 and the like. The hanger points 89 may also be used to support furniture and fixings, such as kitchen cabinets and the like.

In one example, the fixtures, furnishing and internal cladding may include hooks to engage the hanger points 89. In another example, a fixing plate 205 may be used.

FIGS. 10A and 10B illustrates two different examples of a fixing plate 205. This can be used to either split the load of fixings/furniture between several hanger points 89, or to provide small spacing between hanger points 89. This may also allow the hanger points to be offset horizontally.

In the example shown in FIG. 10A, the fixing plate 205 includes a bracket 207 extending in a plane. A pair of hooks 209 are formed along one edge of the bracket. The connector hooks extend in the same plane as the connector plate, and are used to secure the fixing plate to hanger points 89 in the inner frame 53.

The number of hooks shown on the plates is by way of example only. A greater number of hooks may be used to support heavier units.

FIGS. 10C and 10D illustrate, by way of example, kitchen units 210 secured to an inner frame element 53 of a wall 3 using the fixing plates 205 shown in FIG. 10A. FIG. 10C shows the units in perspective view, with the units 210 semi-transparent, to show the plates. FIG. 10D shows the units 210 in side on view.

The units 210 are secured to the connector plates 207 using fixing apertures 206. As can be seen in both FIGS. 10C and 10D, the fixing plates 205 are then secured into the hanger points 89 of the inner frame element 53 and the bracket 207 extends perpendicular to the plane of the wall 3.

The bracket may have any suitable shape. For example, the bracket may extend vertically and/or horizontally. FIGS. 10C and 10D show an example of a bracket 205a used to support a work top that extends the full width of the work top away from the wall 3.

FIG. 10B shows an alternative example of a fixing plate 205. In this example, the hooks 209 extend perpendicular to the bracket 207 rather than parallel. Therefore, the bracket 207 extends parallel to the wall.

As discussed above, fixing apertures 206 are used to fix the plates 207 to the units 210. In one example the fixing apertures 206 may be simple holes, for example for fixing of screws and the like. In other example, the fixing plates 205 may be bonded to units or in another example the fixing plates 205 may be integral to the fixture, such as by forming in one piece.

The fixing plates 205 may be perpendicular to the face of the frame 85 or parallel.

Instead of being used to secure units 210, the brackets 207 may have apertures arranged in the same way as the hanger points, however, the spacing may be different to the hanger points on the frame, such that the pitch of the hanger points is changed.

The structure 1 shown in FIG. 1 and discussed with reference to FIGS. 1 to 10 is a simple rectangular building with a single storey. As discussed above, this is provided by way of example only. By way of further example, FIG. 11 shows a cutaway section of a portion of a structure 1′ with two storeys 211, 213.

The exterior of the structure 1′ (the building envelope) is constructed using the same modules and principles as discussed in relation to the structure 1 in FIG. 1. However, in order to provide the intermediate floor 215 and the second storey 213, additional modules are used.

FIGS. 12A and 12B illustrate the general construction of the floor 215 of the second storey 213. In order to support the floor 215, a floor support module 217 is used. There are four different types of floor support module 217—the first type of floor support 217a is for supporting the centre of a floor over an internal wall module 6 (such as in FIG. 12A), the second type of floor support 217b is for supporting the end of the floor 215 on an external wall 3 of the structure 1 such as in FIG. 12B). The third type of floor support module 217c for supporting the end of floor 215 on an internal wall module 6, such as by the stair case 239 in the structure 1 of FIG. 11. The fourth type of floor support module 217d (not shown) is for supporting a join between floor modules when the join is not over an internal wall module 6.

The first, third and fourth type of floor support modules 217a, 217c, 217d have substantially the same construction of layers as an internal wall module 6.

In the support 217a in the middle of the floor 215, the frame elements 53, 55 on either side of the module 217a the layers contained within the frame (i.e. the service layers 71) on either side only extend for part of the height of the module 217a, forming a shortened layer. In the example shown, an L shaped support bracket 219 is provided on either side of the module, as part of the composite structure. Each bracket 219 may have an upstand 219a extending vertically up the core layer 37, to a top edge 221, and a ledge 219b extending perpendicular to the face of the wall 3, from the bottom of the upstand 219a. In other examples, the bracket 219 may have any suitable shape.

A number of rectangular slots 220 are provided in the ledge 219b. A first subset of the slots 220 have the length of the rectangular slot oriented parallel to the direction of the wall on which the support module 217 is fitted. A second subset of the slots 220 are oriented perpendicular to the first subset.

The support 217c for supporting the end of a floor 215 on an internal wall module 6 has the bracket 219 on only one side of the module. On the other side, the frame element 53, 55 and service layer 71 extend the full height of the module.

The module 217d for supporting a floor module without an internal wall module 6 has no frame elements 53,55 and the core element 37 is replaced with a spanning element, such as a steel beam. An alternative 217e may have the bracket 219 on only one side of the module.

In the support 217b for a floor terminating at an external wall 3, the floor support module 217b has substantially the same construction of layers as an external wall module 5. In a similar manner to the floor support modules 217a, 217c used with internal walls, the inner frame element 53 and service layer 71 are reduced in height, and a bracket 219 is provided to support the floor modules.

The floor 215 itself is formed of floor module 223. These are elongate modules having a box shaped cross section. The floor modules 223 extend between floor supports 217, and provide an upper surface 225 on which a decorative or finishing layer may be provided.

The floor modules 215 are substantially hollow having a top 227 to provide the upper surface 225, and sidewalls 229a,b. Additional a lower surface may optionally be provided to form a ceiling of a lower storey 211. The upper surface 225 and lower surface may include connection points for fixing of a decorative surface for the floor and/or ceiling.

At each end of the floor module 215, a stepped recess 235 is formed on the bottom of the sidewalls 229a,b. A connector plate 235a is located at the top of the stepped recess 235 sits on the ledge 219b of the bracket 219 to support the floor module 215. This stepped recess may be 65 mm wide and 100 mm high and the full width of the floor module 225.

Lugs (not shown) are provided in the lower edge of the connector plate 235a. These engage in slots in the ledge 219b of the floor support modules 217. Therefore, the floor support modules 217 act as load spreaders to the floor modules 215. The connector plate 235a is similar to the connector plates 253 used to connect staircases modules to floors, at the top of stair cases, as will be discussed in more detail below.

Since there are two types of slots at 90 degrees to each other the floor modules 215 self-locate into the right position on the floor support module 217 with an interference fit to guarantee accuracy of placement and stiffen the structure 1 for side loads and resulting spreading.

Openings 231 may be provided in the sides and/or ends of the floor modules to allow connection of services, utilities and the like. Corresponding openings 233 may be formed in the floor supports 217. For floor modules 215 used on the ground floor, inserts may be provided for insulation and waterproofing hung underneath. Inserts may be provided in other floor modules 215 for fireproofing, soundproofing, insulation and the like.

Where a floor 215 forms a mezzanine floor, or extends over a window or door opening that is more than a single module in width a lintel (not shown) may be fitted through the openings 233 in a direction perpendicular to the floor modules 215, to support the structure 1.

As shown in FIG. 11, foundations 237 may be provided to form a base for the walls 5 and structure. As also shown in FIG. 11 the ground floor may also be formed by floor modules 215. The foundations 237 may be shaped to support the floor modules 215 in the same way as the floor 215 of the second storey 213 is supported. It will be appreciated that the foundations and ground floor may be used in the structure 1 of FIG. 1 or any other structure.

The structure 1′ in FIG. 11 also includes a staircase 239 to access the second storey 213. In the example shown, the staircase 239 is formed of a number of identical interconnected staircase modules 241a-c, each extending part of the height of the staircase 239. FIGS. 13A and 13B shows the connection between two staircase modules 241a, 241b which is supported on top of an internal wall module 6. FIG. 13A shows the connection between two staircase modules 241a, 241b in exploded view, whilst FIG. 13B shows the assembled connection in cut-through side view.

Each staircase module 241a-c includes a number of steps 243, each step 243 having a riser 245 and a tread 247. Optionally, an additional nosing layer 249 may be provided on each tread 247 to make the tread 247 overhand the riser 245 beneath it. Stringer elements 251 extend at an inclined angle on each side of the staircase module 241a-c, with the steps 243 fixed between the stringer elements.

Each staircase module 241a-c starts at the riser 245 of the first step and ends in the tread 247 of the top most step. The riser of the upper staircase module 241b in FIG. 13A is omitted for clarity of the drawing.

At the top of each staircase module 241a-c, a first connector plate 253 is provided. The first connector plate 253 is secured in a recess 255 in the underside of the tread 247 of the top most step and extends out from the tread 247.

At the bottom of each staircase module 241a-c, a second connector plate 257 is secured at the bottom of the riser 245 of the first step. The second connector plate 257 is an L shaped bracket having a vertical section 259 extending up the riser 245, and a horizontal portion 261 extending perpendicular to and forward from the riser 245. The horizontal portion 261 is flush with the bottom of the riser 245.

An intermediate plate 263 is provided between the first and second connection plates 253, 257. The intermediate plate 263 has a main body 265 having a thickness equal to the distance from the top of the tread 247 of the top step 243 of the staircase module 243a-c to the top of the recess 255 in which the first connector plate 253 is secured.

The body 265 of the intermediate plate 263 has a top surface 267 and an opposing bottom surface 269, both of which extend parallel to the treads 247 of the steps 243 (and the first connector plate 253 and horizontal section 261 of the second connector plate 257). On each surface 267, 269 projections 271, 273 extend away from the body 265. The projections engage with corresponding apertures 275, 277 in the first and second connection plates 253, 257 to connect the modules.

As with the lugs used to form a connection between the floor module 215, and floor support module 217, the projections 275 and corresponding apertures 275, 277 are split into two different sets extending perpendicular to each other so that bringing the staircase modules 239a, 239b into connection also aligns them and forms an interference fit. The projections may have a tapered end to help pull the modules into connection.

An anchor plate 279 is also provided to secure the staircase module 239 to the top of the wall module 6 which supports the staircase 239. The anchor plate 279 is arranged to extend over the face of the wall module 6. In the overlapping portion, the anchor plate 279 includes openings 281 which align with the openings 275 in the first connector plate 253. Therefore, the projections 271 extending from the bottom surface 269 of the intermediate plate 263 engage with the openings in the anchor plate 279.

At the top of the staircase 239, the staircase 239 connects to a floor module 223 or a wall module 5, 6 or a beam module (not shown). The floor module 223 to which the staircase connects may be modified to form a landing module 283, shown in FIG. 14. If the stair is fully supported between two walls then the landing module is not required and the first connector plate 253 can be simply omitted.

The landing module 283 has a recessed region 285 sized and shaped to receive the first connector plate 253. The recess region has openings 287 aligned with the openings 275 in the first connector plate 253. The top of the landing plate is flush with the top of the landing module.

The landing module may be the same length and width as the other floor modules 215, with the recessed region 285 provided at one or more location to allow for flexibility in the placing of staircases 239. Filler pieces (not shown) may be provided to fill recessed regions 285 not used. These may be provided with or without a nosing 247.

In the example shown in FIGS. 13A and 13B, the joint between staircase modules 241a,b is supported on a wall module 6 or a floor support module 217, as discussed above. The anchor plate 279 may be part of an internal wall module 6 designed to support the staircase module 239a, or may be separate. In other examples, the joint between staircase modules 239a, 239b may be supported from underneath and so may be considered free standing. In this case, the anchor plate 279 is simply omitted since the modules are not attached to anything below.

In the example shown in FIG. 11, the staircase 239 is positioned between two walls 3. It will be appreciated that handrails and other fittings may be provided on either wall.

In other examples, the staircase 239 may be open on one or both sides. FIG. 15 shows an example of a vertical rail 289 that may be secured to the staircase modules 241a-c, and which may be used to support handrails and other fixtures.

At the top and bottom of each stringer 251, a bracket 291 is provided having a plurality of vertically arranged hooked projections 292.

The vertical rail 289 comprises a rebate portion 295 shaped to sit flush with the top of the stringers 251. A post connector plate 297 is provided having slots 295 arranged to align with the hooked projections in the brackets 291 on the stringers 251, to allow connection of the vertical rail 289 to the stringers 251. The hooked projections 292 and slots 295 are arranged such that each vertical rail 289, the slots 295 engage projections 292 from two adjacent staircase modules 239a, 239b.

In other examples, the hooked projections 292 on the brackets 291 may be used to engage hanger points 89 on the inner frame elements 53 of a wall module 5, 6 adjacent the staircase module 239a-c.

Once the staircase 239 is assembled, a decorative finishing layer 301 may also be fitted to cover the fittings and connections on the underside. Furthermore, a wear protection layer 303 (for example a carpet) may be provided on top of the stair modules 241a-c.

In the example discussed above the staircase 239 is straight. However, it will be appreciated that additional staircase modules may be provided of different shapes, such as winder modules or “L” shaped intermediate landing modules.

In the above, a number of basic modules have been discussed. It will be appreciated that the shape and layer composition of the modules may be varied to provide a number of other modules.

FIGS. 16A and 16B illustrate an example of an interior post module 305 for connecting four separate internal wall modules 6 at a central point. For ease of illustration one of the modules is omitted from FIG. 16, and one of the modules is shown with a truncated height.

The interior post module 305 is substantially cross shaped in cross section. The shape of the post 305 will now be described with reference to the cross section, as shown in FIG. 16B. It will be appreciated that the post 305 is of the same cross section along its height, with engagement elements (not shown) at the top and bottom.

The interior post module 305 is made of four projections 306a-d formed at 90 degree intervals to each other, such that a first pair of projections 306a, 306c are diametrically opposed to each other, and a second pair of projections 306b, 306d are also diametrically opposed, perpendicular to the first pair 306a, 306c. The first pair of projections 306a, 306c are arranged centrally with respect to the second pair 306b, 306d, so the post has 90 degree rotational symmetry.

Each projection 306a-d is made of a load bearing core 307a-d that is substantially rectangular in shape, extending the height of the post 305. The load bearing core 307a-d may be wood or other suitable load bearing material.

A stepped recess 308 is formed on both sides of the inner end of each core 307a-d, such that the core has a narrowed neck region towards the centre of the post module 304.

The first pair of projections 306a, 306c, are joined by first linking members 309a, 309b located in the recesses 308 on either side of the cores 307a, 307c. A gap is formed between the projections 306a, 306c in the first pair. The gap is enclosed at the ends by the cores 307a, 307c and on the sides by the linking members 309a, 309b. The length of the gap between the cores 307a, 307c is the same as the width of the neck portion of either core 307a, 307c, perpendicular to the length of the gap. A vertical bar 313, which may be made of the same material as the cores 307a-d, is provided in the gap.

The third projection 306b is secured to a first linking member 309a extending between the first projection 306a and second projection 306c by shortened linking members 309c, 309d located in the recesses 308 of the third projection 306b. Similarly, the fourth projection 306d is connected to the second linking member 309b extending between the first projection 306a and second projection 306c by shortened linking members 309e, 309f located in the recesses 308 of the fourth projection 306d.

Retaining members 310a-h are provided on the outside of each side of each projection 306a-d. These extend over the linking members 309a-f and also the wider portions of the projections 306a-d to the ends of the projections 306a-d.

At the end of each projection, inner frame elements 311a-h are provided on each side of the projections 306a-d. These combine with the core elements 307a-d to bear the load through the post modules 305. Edge members 312a-d are also provided on the outward facing end of each projection, having engagement elements for securing adjacent wall modules 6 to. It will be appreciated that the edge members 312a-d may be integral with the cores 307a-d or formed separately.

The example discussed above is for connecting four walls 6. It will be appreciated that a post can be made to connect three walls 6 in a T shape, or two walls 3 either straight or round a corner, by removing one or both of the second pair of projections 306b, 306d. In the structure of an interior post module 305 having fewer than four projections 306a-d, any faces of the post module 305 without a projection 306a-d are arranged in a similar manner to the structure of an internal wall module 6. This is also similar to the interior side of the posts 11a, 11b discussed in relation to FIGS. 5A and 5B.

Furthermore, it will be appreciated that where a T junction is required between two external walls and an internal wall, the post may be arranged as shown in FIG. 5A or 5B, but for straight through connection, with a projection 306a-d as discussed in relation to FIGS. 16A and 16B provided on the internal side.

FIGS. 17A and 17B show further roof features that can be formed. In particular, FIG. 17A shows the general arrangement of a hip 319 on a roof and FIG. 17B shows a valley 321.

FIGS. 17A and 17B show a section of the roof with the roof cladding panels 323a-d. The dashed lines show the shape of the underlying roof panels 15a-d.

In the case of the hip 318 or valley 321, the roof modules 15b, 15c at the joint are shaped to have an incline on one edge. Furthermore, the edge members one or both of the roof modules 15b, 15c are located facing on the inner face of the roof module 15b, 15c for the hip and the outer face of the roof module 15b, 15d for the valley 321. In this way, when the modules 15b, 15c are joined the hip 319 or valley 321 are formed.

The cladding panels 323b, 323c at the hip 319 or valley 321 are constructed in the same way.

FIGS. 18A and 18B show different examples of porches 325 or canopies 327 that can be fixed over doors. In one example, the porch or canopy may be formed as a cladding module, and secured to the structure in the same way as the cladding 31. In another example, the porch or canopy may be provided as integral to a wall module 5 or door module 7.

It will be appreciated that various features such as, but not limited to, porches 325 or canopies 327, false balconies or Juliet balconies can be provided above or below doors, windows or other openings.

FIG. 18C shows a further example of a door. In this case, multiple doors 329a-d are provided to form a wider opening, such as a sliding door. In this case, a lintel module 331 may be provided for the larger spans to ensure proper load bearing, as discussed above.

In the examples discussed above, corners and posts are arranged at right angles, however, it will be appreciated that modules for alternative angles can be created. Furthermore, in wall modules 5 which form corners, such as shown in FIG. 6, the wall module 5′ may extend for some length on each side of the corner rather than ending at the corner.

Depending on the intended use of the module, various changes can be made. For example, in some modules, layers including one of the frames may be omitted or added. In addition to the layers discussed above further examples of layers include: inner and outer skins, thermal insulation, sound proofing, glazing or transparent layers, protective or security layers, or energy generating layers.

In the above examples, doors, windows and skylights have been discussed as different examples of openings in structures. However, other types of opening may be provided, such as vents, access hatches, service access, serveries (e.g. for food or commercial service).

In some modules, further load bearing capacity may be required. For examples, roof modules 15 may require additional reinforcement. FIG. 19 schematically illustrates a roof module 15′. In this example, reinforcing bars 333, such as aluminium or steel beams, may be provided extending along the length of the module 15′ (oriented down the slope of the roof). These may extend through the centre of the module, for example through the core layer 37. It will be appreciated that similar reinforcement can be provided in any module. Furthermore, depending on the size of module and structural requirements, any number of reinforcing bars 333 may be provided.

The reinforcing bars 333 of adjacent modules may connect together to provide further strengthening.

In addition to or instead of stairs 239, a lift may also be provided to move between a first storey 211 and a second storey 213, and/or a ramp or included surface may be formed. A lift shaft may be formed by omitting floor modules 223 in the region desired. A ramp may be formed in a similar way to the staircase 239, but with an inclined upper surface rather than steps.

Various changes can be made to the modules in order to comply with local building regulations. Furthermore, the exterior finishes can be selected to also comply with local regulations or fit in with local styles.

It will be appreciated that by selecting a collection of different modules from the defined set of modules, a kit for assembling any type of structure 1 can be made. The structure may be a house, an office, a shop, or any other kind of building. Furthermore, the structure may be an extension or annex of an existing building, or an interior structure sub-dividing an existing space. The interchangeability of the relatively small number of modules allows for the modules to be assembled in a plethora of different ways forming different structures.

To ensure full interchangeability of the modules in any location and any structure, the layout of the modules is in accordance with a grid system. In one example, the grid system may be a double grid floor system, as shown in FIG. 20. All the modules are designed to operate in compliance with the defined grid system to allow full interchangeability and a plurality of locations for the modules.

Referring to FIG. 20, the first grid 335 and second grid 337 are both square grids with periodicity w. The grids 335, 337 are offset from each other by a spacing u in both the horizontal and vertical direction. This forms tramlines between the first and second grids 335, 337, with the tramlines forming a square grid pattern.

With reference to the grid, the spacing between adjacent sets the tramlines is of width v.

FIG. 20 shows the floor plan for wall modules 339a-f, a door module 341, a window module 342 and post modules 343, 345, 347, 349 to form the structure shown in FIG. 1, by way of example. The wall modules 339a-f are shown hatched. The post modules 343, 345, 347, 349 are shown shaded with a grid pattern.

In general, wall modules 5, and other elongate modules are considered “on grid” if they are provided between tramlines. Post modules 343, 345, 347, 349 are considered “on grid” if they are where a set of horizontal tramlines and vertical tramlines cross.

The wall modules 339a-f each have a length of w (i.e. the periodicity of one of the grids). It will be appreciated that this provides a single unit length for all modules in the structure 1. In some example, modules may be made integer multiples or fractional multiples of this unit length, but the unit length forms a basis for the layout. The post modules 343, 345, 347, 349 have length and width of u.

As shown in FIG. 20, only a single post 343 is provided on grid. The remaining posts 345, 347, 349 are all off-grid. The walls extending from the on grid post 343, including wall modules 339b-d and the window module 342 are also on grid, whilst all other wall modules are off grid.

By having two walls (and three posts) off grid in this way, the pitched roof 13, including the eaves module 21 and verge module 19 may be made using main roof modules 15 having the same unit length as the wall modules 5.

In other examples, the wall modules may have a unit length of v and posts may be provided after each wall module 5. In this case, all four wall may be on grid and, the roof modules 15 may have different lengths and/or a flat roof may be used.

A separate grid is provided for the vertical elevation The wall (vertical) grid may be a single grid with spacing z. Alternatively, it may be a double grid arrangement. The vertical grid may be the same size as the floor grid, or smaller or lager.

In one non limiting example, the double grid may be set up so that the dimensions may be u=280 mm, v=1200 mm and w=920 mm. In another non-limiting example, the grid may be set up so that the dimensions may be u=300, v=1200 mm and w=900 mm In one example, the vertical grid may have z=1055 mm.

The layout of the modules may also be in accordance with a triple grid wall system or a higher order grid wall system, as will be discussed in more detail below.

Apart from internal wall modules 6, the modules are all made to a size that is an integer multiple of one of the dimensions u, v, w of the grid system (or 0.5 multiple). For example, a wall module 5 with an integrated corner, such as shown in FIG. 6 (or simply a wall module 5 for forming a long wall) may have a size of height, h=z, length, l=u+w and depth d=u. Thus the wall module extends for a length of one wall region 353 and one post region 351. Alternatively a wall module 5 may have height, h=z, length, l=w and depth, d=u. This length does not include the region at each end required to form a connection to adjacent modules, which will overlap other modules when assembled such that the contribution to the finished dimensions is simply the multiple of the grid.

The internal wall modules 6 may have a length and height corresponding to a multiple of a dimension of the grid system, but the thickness may be 130 mm, which is not a multiple of a dimension of the grid system. The internal wall modules may have an L-return or T shape built into the wall. Whilst the thickness of internal walls is not a multiple of the dimensions of the grid, the internal wall modules are placed centrally with respect to the tramlines.

The floor modules may have a width along the direction they are supported that is a fraction of the length of the module. Different floor modules may be provided with lengths (perpendicular to the direction the floor module is supported from) of various integer multiples a dimension of the grid system plus twice the dimension of the fixing 235. For example a floor module may be a single module length, a double module length or more. This allows wide span floors with spacing between support points (which would require internal walls) greater than a single module.

Modules such as post modules may have a length and depth both of u. The height of a post module may be z, an integer multiple of z, or a fraction of z, such as ½z, ⅓z or ⅔z. Likewise, floor support modules 217 and eaves modules 21 may be ½z in height.

In some examples, the elongate vertical elements, such as posts, may have a height corresponding to an integer multiple of z. Similarly, elongated horizontal elements, such as floor modules 215, eaves modules 21 and ridge modules 19 may have a length that is longer than a single wall region, to completely fill an integer number of post and wall regions 351, 353.

To fit into the grid, straight stair modules 241a-c may have length l=w, depth, d=v and height z. In one example, this may include five or six steps 243. A winder stair module may also include five steps and have the same length and depth, l,d=w, and height z. A landing module may have a square area of w×w.

The eaves 21 and ridge modules 19 may be arranged to provide a fixed roof pitch. For example, r may be 41.32° .

Use of the grid design enables all the modules to link together in a predictable manner to support a multitude of bespoke structure layouts with standard interchangeable modules.

Conveniently the floor grid size and wall grid size matches the dimensions in use in the building industry for standard regulation doorway widths and heights, corridors, staircase 239 heights, roof pitch angles r and typical windows and provide automatic compliance to stair angle, stair tread and riser regulations.

Furthermore, any type of module can be utilised as long as it is compliant with the dimensions and the interfaces of the grid and all modules that join together use the same interlocking system.

After manufacture but prior to delivery each module may be labelled and serialised with a 2D barcode or similar non-limiting means which can be read by suitable computer means which predetermines the order of construction of the modular building system onsite, and provides instructions on where the module should be placed.

The layers are made of low density material and/or are made of a size and weight such that the modules can be handled without the use of specialist lifting equipment.

The size of the modules and grid are set so that the modules can be transported by typical pallet moving equipment and carried aloft by personnel without the assistance of specialist lifting equipment making transportation to site and assembly relatively simple and quick and the structure 1 can be constructed in locations where access and space is limited.

Prior to the fitting of the cladding panels 31, the fixing mechanisms used for cladding panels 31 can be temporarily employed for the support of external platforms (scaffolding) for the aid of construction and the safety of the construction workers. The length of scaffolding sections is in compliance with the grid, whilst the other dimensions are in compliance with building regulations. The external platforms can be removed and redeployed as the building is constructed, once removed the cladding panels 31 are fitted.

The above system can be used to make a structure up to three storeys in height. In order to extend the structure over more than three storeys 231, 233, an additional support frame 355 may be required. The support frame 355 is made of steel or other suitable materials. The support frame 355 may be made of modular components with use of any suitable engagement system to facilitate connection with other modules of the support frame 355, and the standard modules discussed above. For example, it may use the same engagement system as is used to join the modules discussed above.

The floor plan and elevation plan of the larger structure may be designed on a quadruple grid layout that is defined by a multiple of the double grid (although this is sometimes referred to as a triple grid), such that wall, window and door modules may be installed between the large spanning modules.

FIG. 21A shows an example of a portion of an additional support frame 355 at a corner of a building, also showing the grid layout used to arrange the modules. The floor plan of a whole building, showing the grid in more detail, is shown in FIG. 21B.

A second double grid pattern is provided for positioning of the support frame. Like the first double grid pattern, this includes two square grids 357, 358 offset from each other to form tramlines, which in turn form a square grid.

The periodicity of one of the grids in the second double grid pattern is such that the support frame is spaced by cubic areas equivalent to two or three stories of the structure 1 shown in FIG. 1 and may be selected to fit an integer number of standard modules with in the grid. For example, the periodicity of the grids in the second double grid pattern may be sized to fit six wall modules between the elements of the support frame 355.

With reference to FIG. 21A, the two square grids 335, 336 of the first double grid pattern are shown in light lines (solid and dashed) whilst the two square grids 357, 358 of the second double grid pattern are shown as heavy lines (solid and dashed). It can be seen that the second double grid forms a similar tramline structure to the first double grid, but with larger spacing within the tramlines and between sets of tramlines.

It can further be seen that the periodicity of the two square grids 357, 358 of the second double grid pattern is a multiple of the periodicity of the two square grids 335, 336 of the first double grid pattern, and so both grids 357, 358 of the second double grid pattern overlap the first grid 335 of the first double grid pattern.

The additional modular support frame 355 shown in FIG. 21A includes three different types of vertical corner support members 359 and two different types of horizontal support members 361.

The first type of vertical supports are outer corner supports 359a. These are provided at the external corners of the structure.

The second type of vertical support is intermediate support 359b. These are provided on exterior sides of the additional support frame 355, away from the corners.

The third type of vertical support 359c is an internal support. This is provided on the interior of the support frame 355, away from the external sides.

FIG. 22 shows a cross section through a vertical corner support member 359 a. It will be assumed that the cross section is the same along the length of the support 359 a.

The outer corner vertical support member 359a includes an “I” shaped structural core element 363 extending vertically. The structure core 363 is formed of a central piece 363a and two end pieces 363b,c Internal frame elements 365a-d, such as provided in the wall modules 5 above, are provided in a square arrangement around core element 363. On the two sides of the core 363 outside the corner formed by the vertical corner support 359, the internal frame elements 365a,b are held spaced from the core 363 by spacers 369. A fire resistant layer 377 may be provided between or affixed to the spacers 369. A services layer 71 may be provided within the frames.

In the outer corner vertical support member 359a, the outer corner is formed by a pair of vertically extending panels, 371, 373 which meet at a vertically extending apex 375. A horizontal fire resistant layer may be incorporated within 371, 373 and 375. The structure core element 363 is fixed on the inside of the corner. A similar configuration is used in the intermediate vertical support (not shown).

Weather proofing 379 and cladding layers 381 may be provided on the exterior of the panels. Fire seals (not shown) may also be provided.

At the end 385, 387 of each panel away from the apex 375, an engagement element 389, 391 is provided. These are for engaging wall panels 5 in the structure as discussed above.

In the intermediate vertical supports 359b, a single vertically extending panel 371 is provided, and the structural core element 363 is fixed to the centre of the panel on one face. Engagement elements are provided on each edge of the panel 371.

The structural core 363 is smaller in size than the square formed by where two sets of tramlines in the double grid arrangement meet. In the assembled frame 355, the outer corner vertical support members 359a are provided so that the structural core 363 is in the corner of the square formed by meeting tramlines, and the panels 371, 373 are formed off grid, on the external sides (with respect to the frame 355) of the square formed by the tramline. The intermediate vertical supports 359b are posited at the centre of one edge, with the panel 371 positioned off grid on the external side of the frame 355.

In the internal vertical supports 359c, no panels are provided and the support is simply made of the structural core element 363 and frame members and spacers 369 and 365, with no vertical engagement elements. This is centrally positioned within the square formed by the tramlines of the second double grid.

As can be seen, the structural cores 363 of the frame 355 are all on grid for the second double grid.

Two types of horizontal support are provided. The first is external horizontal supports 361a. These are provided on external faces of the frame 355. The second type is internal horizontal supports 361b provided within the frame 355.

External horizontal supports 361a have a structural core similar to the vertical supports, internal frame elements and an outer layer 371 truncated in height to match the height of module 361. The internal horizontal supports 361b comprise a structural core and internal frame elements. Engagement elements are provided on each edge of the layer 371. Engagement elements are provided at each end of the structural core of 361a and 361b to connect with the structural core of the connection modules 393a, b, c.

In the assembled support frame 355, the vertical supports 359, 359a, 367 and horizontal supports 361a and 361b are joined by connection modules 393 (also referred to as capping elements). The connection modules 393a, 393b and 393c are similar in construction to the supports, but truncated in length. The connection modules 393a, 393b and 393c have anywhere between two and six engagement elements on opposing faces to join modules at any desired angle. Therefore, the long spanning horizontal or vertical supports 259, 259a, 361, 361a, 367 do not directly connect with each other, but use connection modules 393a, 393b, 393c as hubs to form a structural skeleton.

In the assembled support frame 355, the horizontal supports along the ground may be omitted, depending on the foundation requirements. The assembled support frame 355 defines a three dimensional grid with cubic spaces 395 defined therewithin. Each cubic space 395 has a height equivalent of approximately two storeys of the structures 1, 1′ discussed above. The wall modules 5 (and other vertical modules such as window modules, door modules, corner posts and the like) of the structure connect to vertical corner supports 359a, outer vertical supports 359 and horizontal supports at outer corners or edges 361. The wall panels abut the edges of the intermediate supports (vertical and horizontal).

A structure of almost any size can be made using the additional support frame 355. The construction of the additional support frame discussed above is given by way of example only, and the additional support frame may take any appropriate form. In some examples the connection modules 393a, 393b, 393c may be formed integrally with vertical supports 359, 359a, 359b, 359c, 367 or horizontal supports 361 and 361a.

The modules of the additional support frame 355 may be of a size and weight that they can be handled and installed with conventional heavy lifting equipment. Therefore, the structure can be fully assembled in a step by step process, gradually increasing in height. In the example discussed above, the support frame is used for buildings greater than 3 stories tall. This is by way of example only. In some cases, larger building may be made without the need for the additional frame 355. In other cases, the additional frame may be used for buildings of three stories or fewer.

An example of an interlocking system 1000 for joining modules will now be discussed, with reference to FIGS. 23 to 26.

The interlocking system 1000 is formed from three separate members—a female member 1002, a male member 1004 and a locking member 1006. When two modules are to be joined, the female member 1002 is secured to one edge member 47a-d of a first module, and the male member 1004 to the corresponding edge member 47a-d on the second module. Each module may be manufactured with a female member 1002 and male member 1004 on opposing edges. As such, panels can be easily interconnected along a length extending for a number of modules. The locking member 1006 is used at each joint, to lock the two members together as will be discussed below in more detail. The locations of the male member 1004 and female member 1006 is the same on all external modules and therefore extends clockwise and anticlockwise around the periphery of the building so that the same modules can be used on any face of the building. The internal male-female locations of the interlocks on the internal modules align north-south and east-west because the internal modules are double sided and can be used either way around.

It will be appreciated that the female member 1002 and male member 1004 and locking member 1006 may extend substantially the length of the edge of the module. Alternatively, the members 1002, 1004, 1006 may only extend part of the length of the module. The members 1002, 1004, 1006 may be continuous over their extend, or they may be formed of separate portions spaced along the edge.

FIGS. 23A and 23B show the female member 1002 in plan view and front view respectively. The female member 1002 comprises a shaped elongate body 1008 that has a central front face 1010. On either side of the front face 1010, mounting faces 1012a, 1012b are provided. The front face 1010 extends in a first plane. The mounting faces 1012a,b extend in a second plane, parallel to the first plane but spaced back from the front face 1010 in a perpendicular direction. Sidewalls 1014a, 1014b connect the front face 1010 to the mounting faces 1012a,b and define a channel 1016 behind the front face 1010. The channel 1016 is substantially square in cross section.

In the example shown, fixing holes 1018 are provided in the mounting faces 1012a,b of the female member 1002 for securing the female member 1002 to the edge member 47a-d of a module by screws or other mechanical fixing means.

A number of apertures 1020, 1022, 1024 are also provided in the front face 1010 of the female member 1002, opening through the front face into the channel 1016.

A first aperture 1020, located near the top of the female member 1002 is a transport fixing aperture. As will be discussed in more detail below, this is used to hold the female member 1002 and locking member 1006 in a transport configuration.

A second aperture 1022, below the first aperture 1020, is an elongate location slot. The location slot 1022 is substantially rectangular in shape, having a length extending along the edge of the front face 1010. At the ends of the location slot (defined relative to the elongate length of the face 1010), the aperture is shaped by a region 1028a, 1028b that tapers inwards to a rectangular or square shaped end 1026a, 1026b that is narrower than the centre of the slot 1022.

A third aperture 1024 is an elongate locking slot. The elongate locking slot is substantially rectangular in shape, having a length extending along the edge of the front face 1010. The locking slot 1024 is located below the location slot 1022 on the front facer 1010.

FIG. 24 shows the male member 1004 in more detail. The male member 1004 has an elongate plate 1030 extending along the length of the edge of the module.

Similar to the female member, 1002, the elongate plate 1030 has a number of fixing holes 1032 extending through the plate 1030 for securing it to the edge member 47a-d of the module by screws or other mechanical fixing means. Two projections 1034 1036 are formed extending perpendicular to the plate 1030, away from the edge of the module, when the plate 1030 is fixed to the module. Each projection 1034, 1036 has a height extending along the length of the plate 1030 and a length extending away from the plate 1030, and are substantially rectangular in side on profile.

In the example shown in FIG. 24, the projections 1034, 1036 are formed by making two parallel cuts from one edge of the plate 1030, and folding the portion of the plate 1030 between the cuts to form the projection 1034, 1036. However, this is by way of example only, and the projections can be formed in any way.

The first projection 1034 is a location projection. The location projection 1034 has chamfered corners 1038 on the end of the projection farthest from the plate 1030.

The second projection 1036 is a locking projection, which is provided below the location projection 1034. The locking projection 1036 has top and bottom sides 1040, 1042 extending out from the plate 1030, perpendicular to the plate 1030. A first end 1044 of the projection is formed at the plate 1030, and a second end 1046 is formed away from the plate 1030. The location projection 1034 is longer (i.e. projects farther from the plate 1030) than the locking projection 1036.

A slot 1048 is formed extending through the thickness of the locking projection 1036, from the top edge 1040. The slot is positioned partway between the first end 1044 and second end 1046 and extend part of the height of the locking projection 1036.

The width of slot 1048, measured parallel the direction from the first end 1044 to the second end 1046 of the locking projection 1036 tapers inwards from the top 1040 of the locking projection 1036 to a flat base 1050 of the slot 1048.

Furthermore, where the top 1040 of the locking projection 1036 meets the plate 1030, the locking projection 1036 is profiled or chamfered.

The vertical positions of the location slot 1022 in the female member 1002 and the location projection 1034 on the male member 1004 are such that when the tops of the female member 1002 and male member 1004 are aligned (see FIG. 26C), the bottom 1052 of the location projection 1034 is directly aligned with the bottom 1026b of the location slot 1022. The bottom of the location projection 1034 and the bottom 1026b of the location slot 1022 are precisely positioned to ensure this alignment. The other dimensions of the location projection 1034 and the location slot 1022 are made with some tolerance.

The vertical positions of the locking slot 1024 in the female member 1002 and the locking projection 1036 on the male member 1004 are such that when the tops of the female member 1002 and male member 1004 are aligned (see FIG. 26C), the bottom 1042 of the locking projection 1036 is level with the bottom 1050 of the locking slot 1024. The bottom 1042 of the locking projection 1036 and the bottom 1050 of the locking slot 1024 are precisely positioned to ensure this alignment. The other dimensions of the locking projection 1036 and the locking slot 1024 are made with some tolerance.

FIGS. 25A and 25B show the locking member 1006 in plan view and front view respectively. The locking member 1006 comprises an elongate body 1056 that has a central front face 1058, and sidewalls 1060a, 1060b extending backwards from the front face 1058. Thus the locking member 1006 is substantially square in profile, with a channel 1062 formed in the middle that is open at the rear face (opposite the font face 1058).

The locking member 1006 is sized to fit into the channel 1016 in the female member 1002.

The locking member 1006 has three openings 1064, 1066, 1068 formed in the front face 1058.

The first opening 1064 in the locking member 1006 is a second transport fixing aperture 1064.

The second opening 1066, below the second transport fixing aperture 1064 is a second location slot.

The third opening 1068, below the second location slot 1066, is a second locking slot. This is also rectangular in profile. As will be discussed in more detail below, the top of the second locking slot 1068 is profiled to ensure an interference fit with the locking projection 1036.

The openings 1064, 1066, 1068 in the locking member are positioned vertically such that when the transport fixing apertures 1020, 1064 in the female member 1002 and locking member 1006 are aligned, top of the locking member projects above the top of the female member 1002, and the location and locking slots 1066, 1068 in the locking member 1006 are aligned with the location and locking slots 1022, 1024 in the female member 1002.

Furthermore, the locking slots 1066, 1068 in the locking member 1006 are positioned so that when the tops of the female member 1002, male member 1004 and locking member 1006 are aligned, the bottom 150 of the slot 1048 in the locking projection 1036 on the male member 1004 algins with the top 1070 of the second locking slot 1068 in the locking member.

The length of the location and locking slots 1066, 1068 in the locking member 1006 is longer than the length of the location and locking slots 1022, 1024 in the female member 1002. Therefore, the location and locking slots 1066, 1068 in the locking member are vertically aligned with the location and locking slots 1022, 1024 in the female member 1002, and the location and locking projections 1034, 1036 on the male member 1004, whether the transport fixing apertures 1020, 1064 in the female member 1002 and locking member 1006 are aligned or the tops of the female member 1002, male member 1004 and locking member 1006 are aligned.

When the individual modules are manufactured, the female member 1002, and male member 1004 are secured to the opposite side of the modules. The locking member is fitted into the channel 1016 of the female member 1002, and vertically aligned so that the transport fixing apertures 1020, 1064 in the female member 1002 and locking member 1006 are lined up.

A plastic dowel or pin 1072 or other frangible member, that can be broken with sufficient force, is fitted into the transport fixing apertures 1020, 1064 to hold the female member 1002 and locking member at this first vertical alignment. This forms a first configuration in which the panels can be shipped (see FIG. 26A).

When two modules are joined together, as shown in FIG. 26B, the module with the male member 1004 is slid horizontally up to the module with the female member 1002. The location projection 1034 is slid into the location slots 1022, 1066 in the female member 1002 and locking member 1006 and the locking projection 1036 is slid into the locking slots 1024, 1068 in the female member 1002 and locking member 1006.

Since the location projection 1034 is longer than the locking projection 1036, the location projection 1034 engages the female member 1002 and locking member 1006 before the locking projection 1036.

The chamfered corners 1038 on the location projection 1034, means the two adjacent modules do not have to be precisely vertically aligned when being attached. The tapered ends 1028a,b in the location slot 1022 in the female member 1002 means that the two modules do not have to be precisely horizontally aligned when being attached. As the two modules are being connected the profile of the location projection 1034 and location slot 1022 guide the modules together into a precise location. In the last few millimetres of travel there is an interference fit between the tongue and slot to ensure that the two modules fit together accurately.

In order to fully engage the locking mechanism 1000, the locking member 1006 is driven downwards with sufficient force to break the plastic dowel 1072. This may be, for example, by hitting it with a hammer or mallet. FIG. 26C shows the interlock with the locking member 2006 driven down to form a locked configuration.

The slot 1048 in the locking projection 1036 enables the locking bar 1006 to drop down into place, where the bottom 1050 of the slot 1048 in the locking projection engages the top of the locking slot 1068 in the locking member 1006, and the bottom 1042 of the locking projection 1036 engages the bottom 1054 of the locking slot 1024 in the female member 1002. The top 1055 of the locking slot 1024 in the female member 1002 is located in the region between the slot 1048 in the locking projection 1036 and the plate 1030 from which the locking projection 1036 extends. The top 1055 of the locking slot 1024 in the female member 1002 may be located on the top edge 1040 of the locking projection 1036, or be spaced from the top edge 1040 of the locking projection 1036. The slot 1048 is tapered, in towards the plate 1030 of the male member 1004. Therefore, as the locking member 1006 is driven down the two modules are clamped and the connection between the two modules is tensioned so as to guarantee that the two modules are clamped together with a high force. In the clamped position, the face 1010 of the female member is pulled by the connection between the locking bar 1006 and the slot 1048 in the locking projection 1036 so as to try to distort the face 1010 away from its module towards the other module. This force is significant and ensures that the two modules are clamped and locked together accurately and tightly.

The shaping of the top 1070 of the locking slot 1068 in the locking bar 1006 is tapered inwards. This ensures an interference fit between the locking bar 1006 and the bottom 1050 of the slot 1048 of the locking projection 1036 on the male member 1004.

This fixes the two modules together very tightly. Combined with the alignment of the bottom 1042 of the locking projection 1036 and bottom 1054 of the locking slot 1024 in the female member 1002 ensures a vertical alignment to a greater accuracy than 0.1 mm.

An extraction tool can be used to lift the locking member 1006 to reverse this repeatable process. The locking member 1006 may have removal slots (not shown) near the top of the channel profile 1016 to receive a shaped tool that can be used so that when placed on top of a module a pin or pins can be located into the removal slots in the locking member 1006 and the locking member 1006 can be levered upwards back into transport position so that the panels can be separated.

In the Figures shown, there is a single transport hole 1020, 1064 in each of the female member and locking member 1006. This is by way of example only, any number of transport holes 1020, 1064 may be provided, to support the female member 1002 and locking member in the first configuration. However, it should still be possible to overcome this holding force using, for example, a hammer or mallet.

In the example discussed above, the female and male members 1002, 1004 are secured to the modules by screws or other mechanical fixing means passing through fixing holes. However, this is by way of example only. Any suitable means may be used to secure the female and male members 1002, 1004 to the modules.

Similarly, only a single location slot 1022, 1066 is shown in each of the female member 1002 and locking member 1006, and a single locking slot 1024, 1068 in each of the female member 1002 and locking member 1006, with a single corresponding location projection 1034 and locking projection 1036 on the male member. This is for ease of illustration only and any number of slots 1022, 1066, 1024, 1068 and projections 1034, 1036 can be provided.

In one example, the male member 1004 may comprise four location projections 1034 and six locking tongues 1036 arranged along the height of the module. There may be corresponding slots 1022, 1024, 1066, 1068 in each of the female member 1002 and locking member 1006. However, any number of projections 1034, 1036 with corresponding slots 1022, 1024, 1066, 1068 may be provided.

In one example, the interlocking system may be arranged with location projections 1034 and corresponding slots 1022, 1066 at the top and/or bottom of the module, and additional location projections 1034 and locking projections 1036 and corresponding slots 1022, 1024, 1066, 1068 in between, but this is by way of example only. The projections 1034, 1036 and corresponding slots 1022, 1024, 1066, 1068 can be provided in any vertical order.

The interlocking system 1000 discussed above is only used along vertical connections between modules (i.e. on the sides of modules). At the horizontal connections any other type of interlocking system may be used. For example, the tops and bottoms of the modules may have a simple shaped male projection and a corresponding recess to allow alignment and connection. The projections and recesses may be arranged so that the modules can only be fixed one way up.

The interlocking system discussed above is given by way of example only. Any suitable interlock may be used to connect the modules.

All dimensions and materials discussed above are by way of example only. Any suitable materials and dimensions may be used in the construction of the modules and structures 1, 1′.

1. A system comprising modular parts arranged to be assembled to form at least part of a structure, the system including:
a plurality of interengageable modules arranged to be fixed together;
wherein the plurality of modules comprises at least one module forming an opening in the structure;
wherein each module includes one or more frame elements; and
wherein the modules are arranged such that in the assembled structure, the frame elements of the module at least partly transmit loads between adjacent modules, through the structure.

2. A system as claimed in claim 1, wherein each module has a first face and an opposing second face, the first and second faces parallel to each other and separated by a thickness of the module.

3. A system as claimed in claim 2, wherein each module further includes a first frame at or near the first face of the module, defining a surface parallel to the first face of the module and includes a second frame at or near the second face of the module, defining a surface parallel to the second face of the module.

4. (canceled)

5. A system as claimed in claim 2, wherein each module further includes a peripheral frame element extending around the periphery of the module, between the first face and the second face, the peripheral frame element defining edge faces facing outward from the module, perpendicular to the first face and the second face.

6. (canceled)

7. A system as claimed in claim 1, wherein a first set of the plurality of modules comprises one or more layers and each module in the first set comprises a plurality of layers arranged in a stack, wherein the plurality of layers includes a core material arranged to bind at least some of the plurality of layers into a composite structure, wherein the composite structure is arranged to at least partly transmit loads between adjacent modules.

8. A system as claimed in claim 7, a volume defined between two layers of the plurality of layers and/or one or more frame elements is filled with the core material.

9. (canceled)

10. A system as claimed in claim 6, wherein the one or more layers comprise one or more of: an inner skin; an outer skin;
thermal insulation; a soundproofing layer; a vapour seal layer; a weather resistant layer; a fire resistant layer; a service layer comprising at least a portion of one or more channels for supply of building services and/or removal of waste water and/or rain water; a transparent layer; a glazing layer; a protective or security layer; an energy generating layer for renewable energy generation.

11. A system as claimed in claim 10, wherein the one or more layers include the service layer and wherein the channels are formed in the body of the layers or recessed into a face of the module.

12. A system as claimed in claim 6, wherein at least some of the layers are retained between two frame elements.

13. A system as claimed in claim 6, wherein at least some of the one or more frame elements comprises an opening, and wherein at least some of the layers are received in the central opening of one of the frame elements.

14. A system as claimed in claim 1, wherein at least one face of the module comprises fixation points to suspend internal or external furniture, fixtures, equipment and finishes, or temporary elements for assembling the system, wherein the fixation points are formed in one of the frame elements.

15. (canceled)

16. A system as claimed in claim 1, comprising sealing elements arranged to form seals between adjacent modules, the seals integral with the modules, wherein the seals comprise one or more of: weather/environmental seals, fire seals, acoustic seals.

17. (canceled)

18. A system as claimed in claim 1, wherein the plurality of modules are arranged to form one or more of: walls, a roof, or floor, a staircase; a ramp; a lift shaft.

19. A system as claimed in claim 18, wherein in walls formed by a plurality of modules, modules extending in parallel or non-parallel directions are joined by posts, the posts enclosing conduits for transport of sewage waste, ventilation and rainwater disposal or modules extending in parallel or non-parallel directions are joined by posts wall modules having connecting formations in a face of the module.

20. (canceled)

21. A system as claimed in claim 1, wherein the structure is arranged on an at least a double grid layout, such that at least some of the dimensions of at least some of the modules corresponds to a unit on the grid, wherein the structure defines a closed perimeter, and wherein at least two walls of the perimeter of the assembled structure are arranged off the grid.

22. (canceled)

23. A system as claimed in claim 1, wherein the system is arranged to form a structure having multiple storeys, and wherein each module has a height such that the combination of modules forming the height of a storey has a corresponding to an integer multiple of the height of a step of a staircase in the building.

24. A system as claimed in claim 1, wherein at least some of the modules have a width corresponding to an integer multiple of the depth of a tread of a staircase in the building.

25. (canceled)

26. A system as claimed in claim 18, wherein at least some of the modules form a roof, the system comprising one or more ridge modules arranged to join non-parallel roof modules and one or more eaves modules, each eaves module interengeagable with modules forming walls, and modules forming a roof, wherein the one or more eaves module are arranged such that the roof joins the wall at a non-parallel or perpendicular angle.

27. A system as claimed in claim 26 wherein the eaves module includes a gutter channel for carrying rain water from the roof.

28. (canceled)

29. (canceled)

30. A system as claimed in claim 1, wherein the opening forms one of the following: a door; a window; a rooflight; a vent; an access hatch; a service access; a servery opening.

31-40. (canceled)
